(19) United States
(12) Patent Application Publication
(10) Pub. No.: US 2017/0321115 A1
(43) Pub. Date: Nov. 9, 2017

(54) WAVELENGTH CONVERSION MEMBER, BACKLIGHT UNIT INCLUDING WAVELENGTH CONVERSION MEMBER, LIQUID CRYSTAL DISPLAY DEVICE, AND METHOD OF MANUFACTURING WAVELENGTH CONVERSION MEMBER

(71) Applicant: FUJIFILM Corporation, Tokyo (JP)

(72) Inventors: Ryo SATAKE, Kanagawa (JP); Makoto KAMO, Kanagawa (JP); Naoyoshi YAMADA, Kanagawa (JP); Tatsuya OBA, Kanagawa (JP)

(73) Assignee: FUJIFILM Corporation, Tokyo (JP)

(21) Appl. No.: 15/660,312

(22) Filed: Jul. 26, 2017

Related U.S. Application Data
(63) Continuation of application No. PCT/JP2016/000498, filed on Feb. 1, 2016.

(30) Foreign Application Priority Data
Feb. 2, 2015 (JP) 2015-018860

(51) Int. Cl. C09K 11/02; G02B 5/12; F21V 9/16

(52) U.S. Cl. CPC C09K 11/02; F21V 9/16; G02B 5/12

(57) ABSTRACT

Provided is a wavelength conversion member including: a wavelength conversion layer including at least one kind of quantum dots that are excited by excitation light to emit fluorescence and are dispersed in an organic matrix; an intermediate layer that is provided adjacent to at least one main surface of the wavelength conversion layer; and a barrier layer that is provided adjacent to a main surface of the intermediate layer opposite to the wavelength conversion layer and includes silicon nitride and/or silicon oxynitride as a major component, in which the organic matrix is obtained by curing a curable composition including at least an alicyclic epoxy compound, and the intermediate layer includes a chemical structure A which is bonded to silicon nitride and/or silicon oxynitride as a major component of the barrier layer and a chemical structure B which is bonded to the organic matrix.

### CROSS-REFERENCE TO RELATED APPLICATIONS

This application is a continuation application of International Application No. PCT/JP2016/000498, filed Feb. 1, 2016, the disclosure of which is incorporated herein by reference in its entirety. Further, this application claims priority from Japanese Patent Application No. 2015-018860, filed Feb. 2, 2015, the disclosure of which is incorporated herein by reference in its entirety.

### BACKGROUND OF THE INVENTION

### 1. Field of the Invention

The present invention relates to a wavelength conversion member, a backlight unit including the wavelength conversion member, and a liquid crystal display device, the wavelength conversion member including a wavelength conversion layer including quantum dots which emit fluorescence when irradiated with excitation light. The present invention also relates to a method of manufacturing a wavelength conversion member including a wavelength conversion layer including quantum dots which emit fluorescence when irradiated with excitation light.

### 2. Description of the Related Art

A flat panel display such as a liquid crystal display device (hereinafter, also referred to as “LCD”) has been more widely used as a space-saving image display device having low power consumption. A liquid crystal display device includes at least a backlight and a liquid crystal cell and typically further includes a member such as a backlight-side polarizing plate or a visible-side polarizing plate.

Recently, a configuration in which a wavelength conversion layer including quantum dots (QDs) as a light emitting material is provided in a wavelength conversion member of a backlight unit in order to improve color reproducibility of an LCD has attracted attention (refer to US2012/0113672A and JP2013-544018A). The wavelength conversion member converts the wavelength of light incident from a surface light source so as to emit white light. In the wavelength conversion layer including the quantum dots as a light emitting material, white light can be realized using fluorescence which is emitted by excitation of two or three kinds of quantum dots having different light emitting properties caused by light incident from a surface light source.

The fluorescence emitted from the quantum dots has high brightness and a small full width at half maximum. Therefore, an LCD using quantum dots has excellent color reproducibility. Due to the progress of such a three-wavelength light source technique using quantum dots, the color reproduction range has widened from 72% to 100% in terms of the current TV standard (FHD, National Television System Committee (NTSC)) ratio.

An LCD including a wavelength conversion member in which quantum dots are used has the above-described excellent color reproducibility but, in a case where the quantum dots are photooxidized due to contact with oxygen, has a problem in that the emission intensity decreases (the light fastness is low). Accordingly, in order to realize an LCD with high long-term reliability, it is important to suppress contact between quantum dots and oxygen.

As described in US2012/0113672A and JP2013-544018A, in a general aspect of a wavelength conversion layer including quantum dots as a light emitting material, the quantum dots are substantially dispersed uniformly in an organic matrix (polymer matrix). Therefore, in order to suppress contact between quantum dots and oxygen in a wavelength conversion member, it is important to reduce the oxygen content in a wavelength conversion layer and to suppress contact between quantum dots and oxygen in a wavelength conversion layer.

From the viewpoint of reducing the oxygen content in a wavelength conversion layer, US2012/0113672A describes a configuration in which a substrate (barrier film) having barrier properties which suppresses permeation of oxygen is laminated on a layer including quantum dots in order to protect the quantum dots from oxygen and the like.

Regarding such a barrier film, for example, the following aspects are known: an aspect in which a barrier layer which is formed of an organic layer or an inorganic layer having barrier properties is laminated on a surface of a film-shaped substrate; and an aspect in which a substrate itself is formed of a material having excellent barrier properties without providing the barrier layer thereon. As the inorganic layer having barrier properties, an inorganic layer formed of an inorganic oxide, an inorganic nitride, an inorganic oxynitride, a metal, or the like is preferably used.

From the viewpoint of suppressing contact between quantum dots and oxygen in a wavelength conversion layer, a configuration of using a material having low oxygen permeability as a material of an organic matrix of the wavelength conversion layer can be considered. JP2013-544018A describes an aspect in which a matrix material includes epoxy as an aspect in which quantum dots are protected in domains of a hydrophobic material having impermeability to moisture and oxygen.

### SUMMARY OF THE INVENTION

By using the above-described wavelength conversion layer including an organic matrix having low oxygen permeability in combination with the above-described barrier substrate, photooxidation of quantum dots in the wavelength conversion layer can be effectively suppressed. However, in a case where defects caused by lamination, for example, formation of pores between the organic matrix of the wavelength conversion layer and the barrier substrate, occur in the wavelength conversion member, the respective performances of the organic matrix and the substrate may be insufficient.

The present invention has been made in consideration of the above-described circumstances, and an object thereof is to provide: a wavelength conversion member which has excellent light fastness and can exhibit high brightness durability when incorporated into a liquid crystal display device; and a backlight unit including the same wavelength conversion member.

Another object of the present invention is to provide a liquid crystal display device having excellent light fastness and high long-term reliability of brightness.

Still another object of the present invention is to provide a method of manufacturing a wavelength conversion member which has excellent light fastness and can exhibit high brightness durability when incorporated into a liquid crystal display device.

The present inventors found that a polymer which is obtained by curing a curable composition including an alicyclic epoxy compound is preferable as a matrix material of a wavelength conversion layer having low oxygen permeability. In addition, as a barrier layer which has low oxygen permeability and suppresses a photooxidation reaction of quantum dots, an inorganic layer including silicon nitride or silicon oxynitride as a major component is preferable.

However, it was found that adhesiveness between a polymer, which is obtained by curing a curable composition including an alicyclic epoxy compound, and an inorganic layer including silicon nitride or silicon oxynitride as a major component may be insufficient.

Therefore, the present inventors performed a thorough investigation on a configuration in which a wavelength conversion layer including quantum dots, which are dispersed in an organic matrix obtained by curing a curable composition including an alicyclic epoxy compound, and a barrier layer including silicon nitride and/or silicon oxynitride as a major component can be laminated with high adhesiveness, thereby completing the present invention.

That is, according to the present invention, there is provided a wavelength conversion member comprising:

a wavelength conversion layer including at least one kind of quantum dots that are excited by excitation light to emit fluorescence and are dispersed in an organic matrix;

an intermediate layer that is provided adjacent to at least one main surface of the wavelength conversion layer, and

a barrier layer that is provided adjacent to a main surface of the intermediate layer opposite to the wavelength conversion layer and includes silicon nitride and/or silicon oxynitride as a major component.

in which the organic matrix is obtained by curing a curable composition including at least an alicyclic epoxy compound, and

the intermediate layer includes a chemical structure A which is bonded to silicon nitride and/or silicon oxynitride as a major component of the barrier layer and a chemical structure B which is bonded to the organic matrix.

In this specification, “barrier layer including silicon nitride and/or silicon oxynitride as a major component” refers to a barrier layer including 90 mass % or higher of silicon nitride, silicon ox nitride, or a mixture of silicon nitride and silicon oxynitride.

In addition, in this specification, “adjacent to” represents “in direct contact with”.

It is preferable that the barrier layer includes silicon nitride as a major component.

It is preferable that the intermediate layer includes the chemical structure A and the chemical structure B in an organic layer.

The chemical structure A may be bonded to the intermediate layer through a chemical structure C, or may be included as an adherence agent having the chemical structure A without being bonded to the intermediate layer.

The chemical structure B may be bonded to the intermediate layer through a chemical structure D, or may be included as an adherence agent having the chemical structure B without being bonded to the intermediate layer.

In this specification, an adherence agent represents both a compound included in a raw material solution of the intermediate layer and a partial structure of the intermediate layer which has the chemical structure A and/or the chemical structure B and is bonded to the organic matrix of the barrier layer or the wavelength conversion layer.

It is preferable that the chemical structure A is a structure which forms a covalent bond with silicon nitride and/or silicon oxynitride as a major component of the barrier layer or a structure which forms a hydrogen bond with silicon nitride and/or silicon oxynitride as a major component of the barrier layer.

As the chemical structure A which forms a covalent bond with silicon nitride and/or silicon oxynitride as a major component of the barrier layer, a structure which forms a siloxane bond with silicon nitride and/or silicon oxynitride as a major component of the barrier layer is preferable.

As the chemical structure A which forms a hydrogen bond with silicon nitride and/or silicon ox-nitride as a major component of the barrier layer, a structure which forms a hydrogen bond with silicon nitride and/or silicon oxynitride as a major component of the barrier layer based on at least one of an amino group, a mercapto group, or a urethane structure is preferable.

In the wavelength conversion member according to the present invention, the chemical structure A may adopt an aspect where a compound having the chemical structure A is dispersed in the organic matrix or an aspect where the chemical structure A is bonded to the organic matrix through the chemical structure B.

It is preferable that the chemical structure B is a structure which forms a covalent bond or a hydrogen bond with the organic matrix.

As the chemical structure B which forms a covalent bond with the organic matrix, a structure which forms a covalent bond with the organic matrix based on at least one of an amino group, a mercapto group, or an epoxy group is preferable.

As the chemical structure B which forms a hydrogen bond with the organic matrix, a structure which forms a hydrogen bond with the organic matrix based on at least one of an amino group, a carboxyl group, or a hydroxy group is preferable.

As the alicyclic epoxy compound which forms the organic matrix when cured, the following alicyclic epoxy compound I can be preferably used.

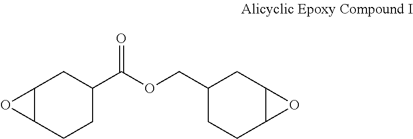 [SMILES: O=C(OCC1CCC2OC2C1)C1CCC2OC2C1]

According to the present invention, there is provided a backlight unit comprising:

a surface light source that emits primary light;

the wavelength conversion member according to the present invention that is provided on the surface light source;

a retroreflecting member that is disposed to face the surface light source with the wavelength conversion member interposed therebetween; and

a reflection plate that is disposed to face the wavelength conversion member with the surface light source interposed therebetween,

in which the wavelength conversion member is excited by excitation light, which is at least a portion of the primary light emitted from the surface light source, to emit the fluorescence and emits at least light which includes secondary light including the fluorescence.

According to the present invention, there is provided a liquid crystal display device comprising:

the backlight unit according to the present invention; and

a liquid crystal cell unit that is disposed to face the retroreflecting member side of the backlight unit.

According to the present invention, there is provided a method of manufacturing a wavelength conversion member,

the wavelength conversion member including

a wavelength conversion layer including at least one kind of quantum dots that are excited by excitation light to emit fluorescence and are dispersed in an organic matrix,

an intermediate layer that is provided adjacent to at least one main surface of the wavelength conversion layer, and

a barrier layer that is provided adjacent to a main surface of the intermediate layer opposite to the wavelength conversion layer and includes silicon nitride and/or silicon oxynitride as a major component, and

the method comprising:

a step of forming the barrier layer on a substrate;

a step of forming a coating film of a raw material solution of the intermediate layer by applying the raw material solution to a surface of the barrier layer, the raw material solution including an adherence agent which is bondable to silicon nitride and/or silicon oxynitride and an adherence agent which is bondable to the organic matrix, or the raw material solution including an adherence agent which is bondable to silicon nitride and/or silicon oxynitride and is bondable to the organic matrix;

a step of forming the intermediate layer by curing the coating film:

a step of forming a coating film of the curable composition by applying a quantum dot-containing curable composition including the quantum dots and an alicyclic epoxy compound to a surface of the intermediate layer; and

a curing step of photocuring or thermally curing the coating film.

In this specification, “inorganic layer” is a layer including an inorganic material as a major component and is preferably a layer consisting only of an inorganic material. On the other hand, “organic layer” is a layer including an organic material as a major component in which the content of the organic material is preferably 50 mass % or higher, more preferably 80 mass % or higher, and still more preferably 90 mass % or higher.

In addition, in this specification, “full width at half maximum” of a peak refers to the width of the peak at ½ the height of the peak. In addition, light having a center emission wavelength in a wavelength range of 430 nm to 480 nm is called blue light, light having a center emission wavelength in a wavelength range of 500 nm or longer and shorter than 600 nm is called green light, and light having a center emission wavelength in a wavelength range of 600 nm to 680 nm is called red light.

In this specification, the moisture permeability of the barrier layer is a value measured under conditions of measurement temperature: 40° C. and relative humidity: 906 RH using a method (calcium method) described in G NISATO, P. C. P. BOUTEN, P. J. SLIKKERVEER et al., SID Conference Record of The International Display Research Conference, pages 1435-1438. In this specification, the unit of the moisture permeability is [g/(m²·day·atm)]. A moisture permeability of 0.1 g/(m²·day·atm) corresponds to 1.14×10⁻¹¹ g/(m²·s·Pa) in SI units.

In this specification, the oxygen permeability is a value measured using an oxygen permeability measuring device (OX-TRAN 2/20 (trade name), manufactured by Mocon Inc.) under conditions of measurement temperature: 23° C. and relative humidity: 90%. In this specification, the unit of the oxygen permeability is [cm³/(m²·day·atm)]. An oxygen permeability of 1.0 cm³/(m²·day·atm) corresponds to 1.14×10⁻¹ fm/(s·Pa) in SI units.

The wavelength conversion member according to the present invention includes: a wavelength conversion layer including at least one kind of quantum dots that are excited by excitation light to emit fluorescence and are dispersed in an organic matrix having high barrier properties; an intermediate layer that is provided adjacent to at least one main surface of the wavelength conversion layer; and a barrier layer having higher barrier properties that is provided adjacent to a main surface of the intermediate layer opposite to the wavelength conversion layer, in which the intermediate layer includes the chemical structure A which is bonded to silicon nitride and/or silicon oxynitride as a major component of the barrier layer, and the chemical structure B which is bonded to the organic matrix. In the above-described configuration, permeation of oxygen into the wavelength conversion layer is effectively prevented, and a decrease in the emission intensity caused by photooxidation of the quantum dots in the wavelength conversion layer can be suppressed. Further, the wavelength conversion layer and the barrier layer are adhered to each other through the intermediate layer. Therefore, oxygen is not likely to permeate from a non-adhered portion between the wavelength conversion layer and the barrier layers. Accordingly, according to the present invention, it is possible to provide: a wavelength conversion member which has excellent light fastness and can exhibit high brightness durability when incorporated into a liquid crystal display device; and a backlight unit including the same wavelength conversion member.

### BRIEF DESCRIPTION OF THE DRAWINGS

FIG. 1 is a cross-sectional view showing a schematic configuration of a backlight unit including a wavelength conversion member according to an embodiment of the present invention.

FIG. 2 shows a cross-sectional view showing a schematic configuration of a wavelength conversion member according to an embodiment of the present invention and a partially enlarged view showing the vicinity of a wavelength conversion layer-barrier layer interface (a schematic diagram showing a first aspect of chemical structures A and B).

FIG. 3A is a schematic diagram showing a second aspect of the chemical structures A and B in the vicinity of the wavelength conversion layer-barrier layer interface of the wavelength conversion member shown in FIG. 2.

FIG. 3B is a schematic diagram showing a third aspect of the chemical structures A and B in the vicinity of the wavelength conversion layer-barrier layer interface of the wavelength conversion member shown in FIG. 2.

FIG. 3C is a schematic diagram showing a fourth aspect of the chemical structures A and B in the vicinity of the wavelength conversion layer-barrier layer interface of the wavelength conversion member shown in FIG. 2.

FIG. 3D is a schematic diagram showing a fifth aspect of the chemical structures A and B in the vicinity of the wavelength conversion layer-barrier layer interface of the wavelength conversion member shown in FIG. 2.

FIG. 4 is a diagram showing a schematic configuration of an example of a device for manufacturing a wavelength conversion member according to an embodiment of the present invention.

FIG. 5 is an enlarged view showing a part of the manufacturing device shown in FIG. 4.

FIG. 6 is a cross-sectional view showing a schematic configuration of a liquid crystal display device including a backlight unit according to an embodiment of the present invention.

### DESCRIPTION OF THE PREFERRED EMBODIMENTS

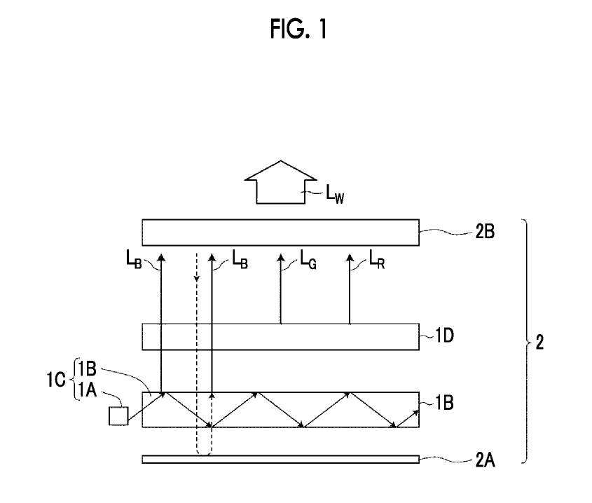

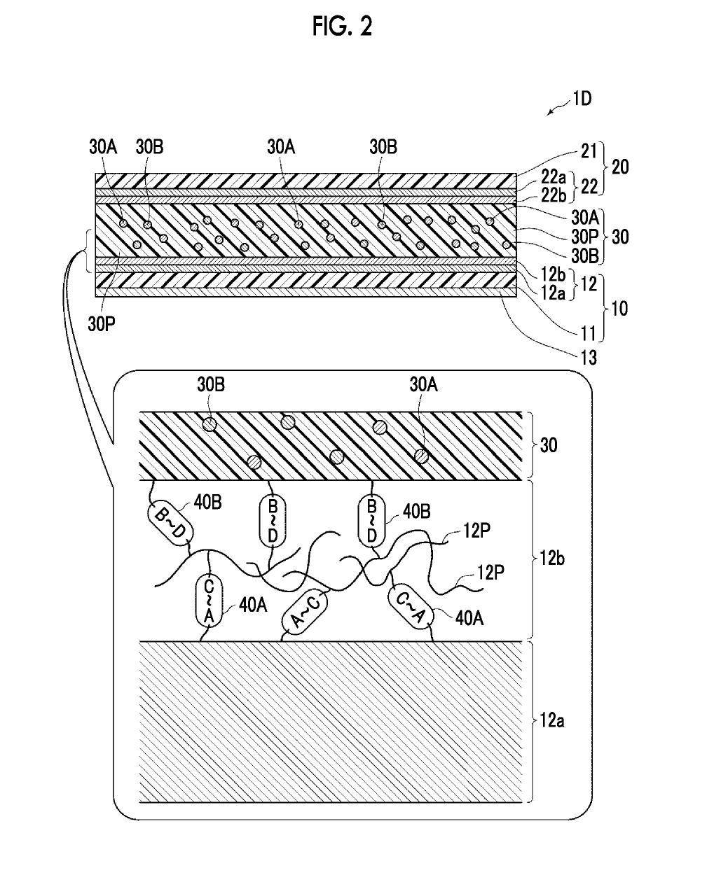

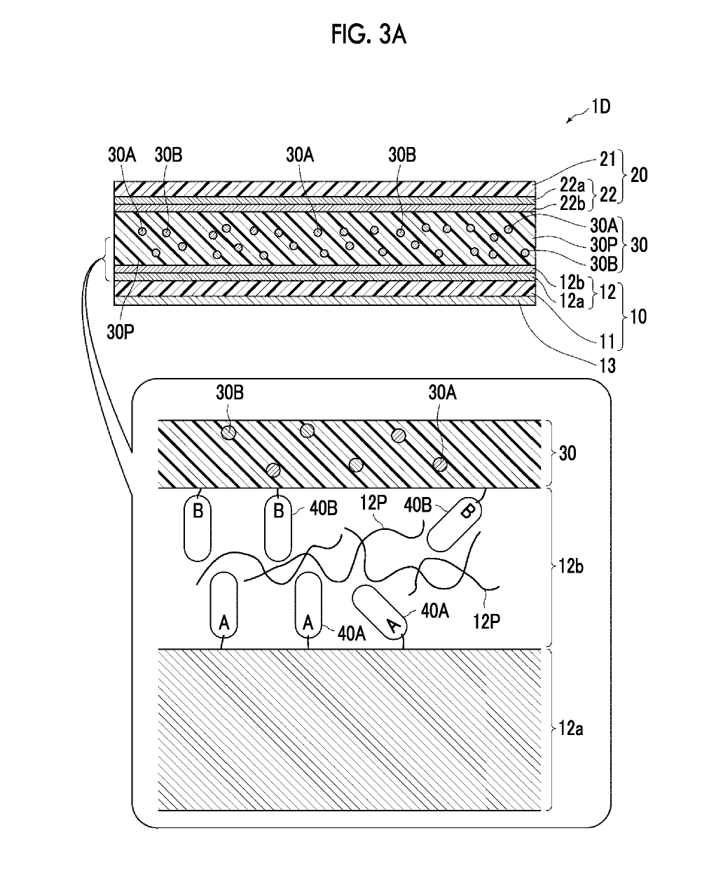

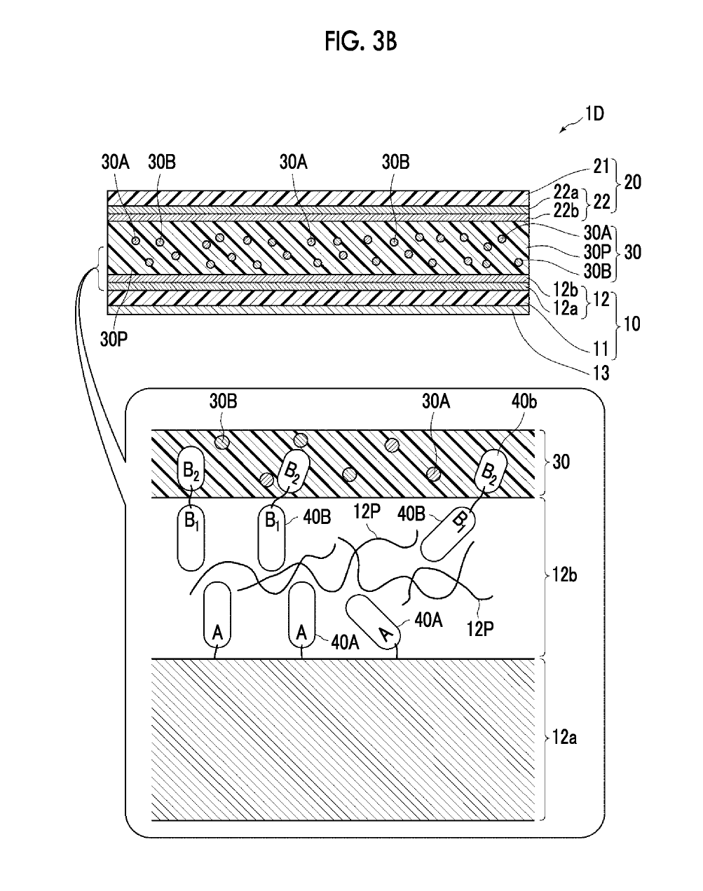

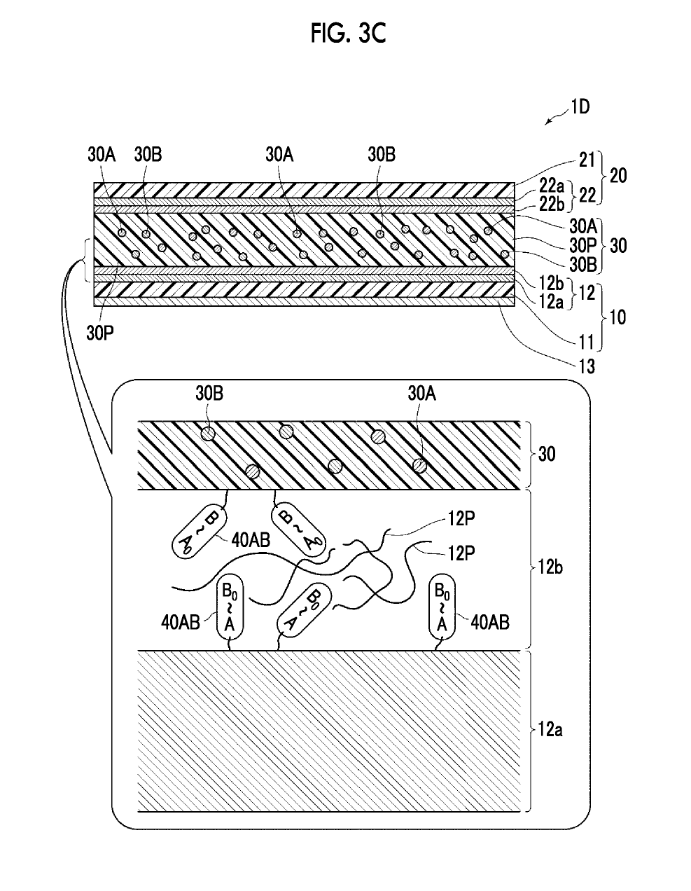

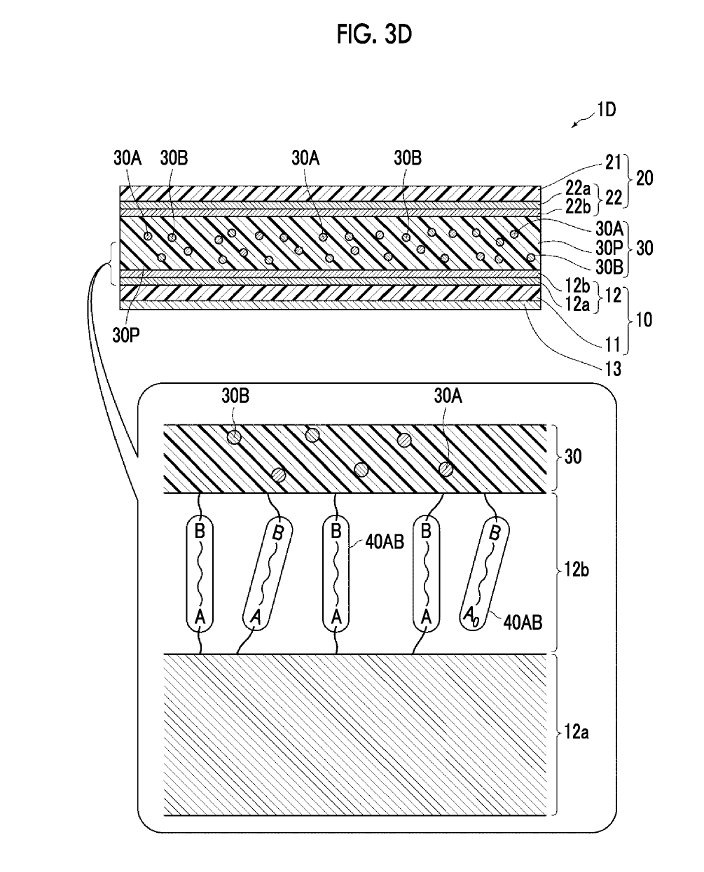

A wavelength conversion member according to an embodiment of the present invention and a backlight unit including the wavelength conversion member will be described with reference to the drawings. FIG. 1 is a cross-sectional view showing a schematic configuration of the backlight unit including the wavelength conversion member according to the embodiment. FIGS. 2 and 3A to 3D are cross-sectional views showing schematic configurations of the wavelength conversion member according to the embodiment and partially enlarged views showing the vicinity of a wavelength conversion layer-barrier layer interface (schematic diagrams showing first to fifth aspects of a chemical structure A). In FIGS. 2 and 3A to 3D, the quantum dots 30A and 30B are enlarged and shown in order to easily recognize the quantum dots. Actually, for example, the thickness of the wavelength conversion layer 30 is 50 to 100 μm, and the diameter of the quantum dot is about 2 to 7 nm.

In the drawings of this specification, dimensions of respective portions are appropriately changed in order to easily recognize the respective portions. In this specification, numerical ranges represented by “to” include numerical values before and after “to” as lower limit values and upper limit values.

As shown in FIG. 1, the backlight unit 2 includes: a surface light source 1C including a light source 1A, which emits primary light (blue light L_{B}), and a light guide plate 1B which guides and emits the primary light emitted from the light source 1A; a wavelength conversion member 1D that is provided on the surface light source 1C; a retroreflecting member 2B that is disposed to face the surface light source 1C with the wavelength conversion member 1D interposed therebetween; and a reflection plate 2A that is disposed to face the wavelength conversion member 1D with the surface light source 1C interposed therebetween. The wavelength conversion member 1D are excited by excitation light, which is at least a portion of the primary light L_{B} emitted from the surface light source 1C, to emit fluorescence and emits secondary light (L_{G}, L_{R}) which includes the fluorescence and the primary light L_{B} which has passed through the wavelength conversion member 1D.

The shape of the wavelength conversion member 1D is not particularly limited and may be an arbitrary shape such as a sheet shape or a bar shape.

In FIG. 1, L_{B}, L_{G}, and L_{R} emitted from the wavelength conversion member 1D are incident on the retroreflecting member 2B, and each incident light is repeatedly reflected between the retroreflecting member 2B and the reflection plate 2A and passes through the wavelength conversion member 1D multiple times. As a result, in the wavelength conversion member 1D, a sufficient amount of the excitation light (blue light L_{B}) is absorbed by quantum dots 30A and 30B, a sufficient amount of fluorescence (L_{G}, L_{R}) is emitted, and white light L_{W} is realized and emitted from the retroreflecting member 2B.

In a case where ultraviolet light is used as the excitation light, by causing ultraviolet light as excitation light to be incident on a wavelength conversion layer 30 including quantum dots 30A, 30B, and 30C (not shown), white light L_{W} can be realized by red light emitted from the quantum dots 30A, green light emitted from the quantum dots 30B, and blue light emitted from the quantum dots 30C.

[Wavelength Conversion Member]

The wavelength conversion member 1D includes: the wavelength conversion layer 30 including the quantum dots 30A and 30B that are excited by excitation light (L_{B}) to emit fluorescence (L_{G}, L_{R}) and are dispersed in an organic matrix 30P; intermediate layers 12b and 22b each of which is provided adjacent to at least one main surface of the wavelength conversion layer 30; and barrier layers 12a and 22a each of which is provided adjacent to a main surface (surface) of each of the intermediate layers 12b and 22b opposite to the wavelength conversion layer 30 and includes silicon nitride and/or silicon oxynitride as a major component. The organic matrix 30P is obtained by curing a curable composition including at least an alicyclic epoxy compound.

The intermediate layers 12b and 22b include a chemical structure A which is bonded to silicon nitride and/or silicon oxynitride as a major component of the barrier layers 12a and 22a and a chemical structure B which is bonded to the organic matrix 30P (FIG. 2).

In the wavelength conversion layer 30 according to the embodiment, barrier films 10 and 20 are provided over opposite main surfaces (surfaces) with the intermediate layers 12b and 22b, which are layers covering the barrier layers, interposed therebetween. The barrier films 10 and 20 include substrates 11 and 21 and barrier layers 12a and 22a supported on surfaces of the substrates 11 and 21, respectively.

In FIG. 2, in the wavelength conversion member 1D, the upper side (the barrier film 20 side) is the retroreflecting member 2B side in the backlight unit 2, and the lower side (the barrier film 10 side) is the surface light source 1C side in the backlight unit 2. Permeation of oxygen and water, which has permeated into the wavelength conversion member 1D, into the wavelength conversion layer 30 from the retroreflecting member 2B side and the surface light source 1C side is suppressed by the barrier films 10 and 20.

In the embodiment, the barrier layers 12a and 22a are formed on the substrates 11 and 21, respectively, but the present invention is not limited to this configuration. Each of the barrier films 10 and 20 may include a barrier layer that is not formed on a substrate.

In the wavelength conversion member 1D, the barrier film 10 includes an unevenness imparting layer (mat layer) 13 which imparts an uneven structure to a surface of the barrier film 10 opposite to the wavelength conversion layer 30 side. In the embodiment, the unevenness imparting layer 13 also functions as a light diffusion layer.

FIGS. 2 and 3A to 3D are partially enlarged views schematically showing states in which an adherence agent 40 (40A, 40B, 40AB) included in the intermediate layer 12b, the wavelength conversion layer 30, and the barrier layer 12a are bonded to each other (FIG. 2 shows the first aspect and FIGS. 3A to 3D show the second to fifth aspects). The partially enlarged view only shows the state where the surface of the wavelength conversion layer 30 on the mat layer 13 side and the barrier layer 12a are bonded to each other in the wavelength conversion member 1D. However, a state where the surface of the wavelength conversion layer opposite to the mat layer 13 side and the barrier layer 22a are bonded to each other may also have the same configuration as described above.

In the first aspect shown in the partially enlarged view of FIG. 2, the chemical structure A in the intermediate layer 12b is included in an adherence agent 40A and is bonded to silicon nitride and/or silicon oxynitride as a major component of the barrier layer 12a. In addition, the chemical structure B is included in an adherence agent 40B and is bonded to the organic matrix 30P of the wavelength conversion layer 30. The adherence agent 40A including the chemical structure A is bonded to an organic matrix 12P of the intermediate layer 12b through a chemical structure C, and the adherence agent 40B including the chemical structure B is bonded to the organic matrix 12P of the intermediate layer 12b through a chemical structure D. In addition, the adherence agent 40A or 40B may be included in the intermediate layer 12b without forming the chemical structure A, the chemical structure B, the chemical structure C, or the chemical structure D.

In the second aspect shown in FIG. 3A, the chemical structure A in the intermediate layer 12b is included in the adherence agent 40A, and the chemical structure B is included in the adherence agent 40B. Both the adherence agents 40A and 40B are included in the intermediate layer 12b without forming a bond with the organic matrix 12P of the intermediate layer 12b.

The third aspect shown in FIG. 3B has the same configuration as the second aspect except for the state where the chemical structure B is bonded to the organic matrix 30P. In the third aspect, a chemical structure B₁ is bonded to a chemical structure B₂ of an adherence agent 40b included in the organic matrix 30P of the wavelength conversion layer 30.

In the fourth aspect and the fifth aspect shown in FIGS. 3C and 3D, the intermediate layer 12b includes an adherence agent 40AB having a structure A₀ which can form the chemical structure A and structure B₀ which can form the chemical structure B. In FIGS. 3C and 3D, the intermediate layer 12b includes not only the adherence agent 40AB in which the chemical structure A and/or the chemical structure B is formed but also the adherence agent 40AB including the chemical structure A₀ or B₀ which is not converted into the chemical structure A or the chemical structure B.

In the aspect shown in FIG. 3C, the adherence agent 40AB is not bonded to the matrix 12P of the intermediate layer 12b. However, the adherence agent 40AB may be bonded to the matrix 12P.

In addition, the fifth aspect shown in FIG. 3D has the same configuration as the fourth aspect, except that both the chemical structure A and the chemical structure B are formed by one molecule (including a polymer or an oligomer) of the adherence agent 40AB.

The chemical structure A is not particularly limited as long as it is a structure which is bonded to silicon nitride and/or silicon oxynitride as a major component of the barrier layer. Preferable examples of the chemical structure A include a structure which forms a covalent bond or a hydrogen bond with silicon nitride and/or silicon oxynitride.

As the chemical structure A which forms a covalent bond with silicon nitride and/or silicon oxynitride as a major component of the barrier layer, a structure which forms a siloxane bond with silicon nitride and/or silicon oxynitride as a major component of the barrier layer is preferable.

In addition, as the chemical structure A which forms a hydrogen bond with silicon nitride and/or silicon oxynitride as a major component of the barrier layer, a structure which forms a hydrogen bond with silicon nitride and/or silicon oxynitride as a major component of the barrier layer based on at least one of an amino group, a mercapto group, or a urethane structure is preferable.

The chemical structure B is not particularly limited as long as it is a structure which is bonded to the organic matrix 30P. It is preferable that the chemical structure B is a structure which forms a covalent bond or a hydrogen bond with the organic matrix 30P. It is more preferable that the chemical structure B is bonded to a chemical structure of an organic matrix derived from an alicyclic epoxy compound.

As the chemical structure B which forms a covalent bond with the organic matrix 30P, a structure which forms a covalent bond with the organic matrix 30P based on at least one of an amino group, a mercapto group, or an epoxy group is preferable.

As the chemical structure B which forms a hydrogen bond with the organic matrix 30P, a structure which forms a hydrogen bond with the organic matrix 30P based on at least one of an amino group, a carboxyl group, or a hydroxy group is preferable.

In FIG. 2, the chemical structure C which is bonded to the organic matrix 12P of the intermediate layer 12b and the chemical structure A, or the chemical structure D which is bonded to the organic matrix 12P of the intermediate layer 12b and the chemical structure B is not particularly limited as long as it is a structure which is bonded to the organic matrix 12P. It is preferable that the chemical structure B is a structure which forms a covalent bond or a hydrogen bond with the organic matrix 12P. As the structure which forms a covalent bond with the organic matrix 12P, a structure which is obtained by polymerization and is bonded to the organic matrix 12P as a part of a main chain of a polymer of a polymer matrix as the organic matrix 12P, or a structure which is bonded to the organic matrix 12P as a side chain or a side group of the polymer of the polymer matrix is preferable.

Specific examples of the adherence agent 40 which can form the chemical structure A and/or the chemical structure B will be described in detail in the description of a curable composition below.

As described in detail in the item of “Summary”, as the configuration capable of suppressing the photooxidation of the quantum dots 30A and 30B in the wavelength conversion layer 30 of the wavelength conversion member, a configuration in which an organic matrix obtained by curing a curable composition including an alicyclic epoxy compound is used as the organic matrix 30P of the wavelength conversion layer 30 and in which an inorganic layer including silicon nitride or silicon oxynitride as a major component is used as the barrier layer was conceived. However, in the above-described configuration, in order to simultaneously realize light fastness and high front brightness when the wavelength conversion member is incorporated into a liquid crystal display device, it is necessary to improve adhesiveness between the wavelength conversion layer 30 and the barrier layers 12a and 22a.

As described above, in the wavelength conversion member 1D, the wavelength conversion layer 30 and the barrier layers 12a and 22a are bonded to each other through the intermediate layers 12b and 22b, in which the wavelength conversion layer 30 includes the quantum dots 30A and 30B which are dispersed in the organic matrix 30P obtained by curing a curable composition including an alicyclic epoxy compound, and the intermediate layers 12b and 22b include the chemical structure A which is bonded to silicon nitride and/or silicon oxynitride as a major component of the barrier layers 12a and 22a and the chemical structure B which is bonded to the organic matrix. In the above-described configuration, permeation of oxygen into the wavelength conversion layer 30 is effectively prevented, and a decrease in the emission intensity caused by photooxidation of the quantum dots 30A and 30B in the wavelength conversion layer 30 can be suppressed. Further, adhesiveness between the wavelength conversion layer 30 and the barrier layers 12a and 22a is high. Therefore, in a case where the wavelength conversion member is incorporated into a liquid crystal display device, oxygen is not likely to permeate from a non-adhered portion between the wavelength conversion layer and the barrier layers. Accordingly, the wavelength conversion member 1D and the backlight unit 2 including the same has excellent light fastness and can exhibit high brightness durability when incorporated into a liquid crystal display device.

Hereinafter, each component of the wavelength conversion member 1D will be described, and then a method of manufacturing the wavelength conversion member will be described.

[Wavelength Conversion Layer]

In the wavelength conversion layer 30, the quantum dots 30A and the quantum dots 30B are dispersed in an organic matrix 30P, in which the quantum dots 30A are excited by the blue light L_{B} to emit the fluorescence (red light) L_{R}, and the quantum dots 30B are excited by the blue light La to emit the fluorescence (green light) L_{G}.

The thickness of the wavelength conversion layer 30 is preferably in a range of 1 to 500 μm, more preferably in a range of 10 to 250 μm, and still more preferably in a range of 30 to 150 μm. It is preferable that the thickness is 1 μm or more because a high wavelength conversion effect can be obtained. In addition, it is preferable that the thickness is 500 μm or less because, in a case where the wavelength conversion member is incorporated into a backlight unit, the thickness of the backlight unit can be reduced.

Alternatively, in the wavelength conversion layer 30, the quantum dots 30A, the quantum dots 30B, and the quantum dots 30C may be dispersed in the organic matrix 30P, in which the quantum dots 30A are excited by ultraviolet light L_{UV} to emit the fluorescence (red light) L_{R}, the quantum dots 30B are excited by the ultraviolet light L_{UV} to emit the fluorescence (green light) L_{G}, and the quantum dots 30C are excited by the ultraviolet light L_{UV} to emit the fluorescence (blue light) L_{B}. The shape of the wavelength conversion layer is not particularly limited and may be an arbitrary shape.

The wavelength conversion layer 30 can be formed by curing a quantum dot-containing curable composition including the quantum dots 30A and 30B and a curable compound which forms the organic matrix 30P when cured (hereinafter, basically referred to as “quantum dot-containing curable composition”). The curable compound which forms the organic matrix 30P when cured includes an alicyclic epoxy compound. That is, the wavelength conversion layer 30 is a cured layer obtained by curing the quantum dot-containing curable composition. In addition, in the fourth aspect, the wavelength conversion layer 30 includes a compound (adherence agent) 40b which forms the chemical structure B₂ when bonded to the chemical structure B₁ of the intermediate layer. The adherence agent 40b does not have an adverse effect on the curing reaction of the curable composition including the quantum dots.

[Quantum Dot-Containing Curable Composition]

The quantum dot-containing curable composition includes the quantum dots 30A and 30B (further includes the adherence agent 40b only in the fourth aspect) and a curable compound including an alicyclic epoxy compound which forms the organic matrix 30P when cured. The quantum dot-containing curable composition further includes other components such as a polymerization initiator in addition to the above-described components.

A method of preparing the quantum dot-containing curable composition is not particularly limited and may be prepared according to a preparation procedure of a general polymerizable composition. In an aspect including the adherence agent 40b, it is preferable that the adherence agent 40b is added at a final stage of the preparation of the composition in order to reduce factors which impair bonding between the adherence agent 40b and the adherence agent 40B included in the intermediate layer 12b.

<Quantum Dots>

The quantum dots may include two or more kinds of quantum dots having different light emitting properties. In the embodiment, the quantum dots include the quantum dots 30A which are excited by the blue light L_{B} to emit the fluorescence (red light) L_{R} and the quantum dots 30B which are excited by the blue light L_{B} to emit the fluorescence (green light) L_{G}. In addition, the quantum dots may include the quantum dots 30A which are excited by the ultraviolet light L_{UV} to emit the fluorescence (red light) L_{R}, the quantum dots 30B which are excited by the ultraviolet light L_{UV} to emit the fluorescence (green light) L_{G}, and the quantum dots 30C which are excited by the ultraviolet light L_{UV} to emit the fluorescence (blue light) L_{B}.

Examples of well-known kinds of quantum dots include the quantum dots 30A having a center emission wavelength in a wavelength range of 600 nm to 680 nm, the quantum dots 30B having a center emission wavelength in a wavelength range of 520 nm to 560 nm, and the quantum dots 30C (which emit blue light) having a center emission wavelength in a wavelength range of 400 nm to 500 nm.

In addition to the above description, the details of the quantum dots can be found in, for example, paragraphs “0060” to “0066” of JP2012-169271 A, but the present invention is not limited thereto. As the quantum dots, a commercially available product can be used without any particular limitation. From the viewpoint of improving durability, core-shell semiconductor nanoparticles are preferable. As a core, II-VI semiconductor nanoparticles, III-V semiconductor nanoparticles, and multi-component semiconductor nanoparticles can be used. Specific examples of the core include CdSe, CdTe, CdS, ZnS, ZnSe, ZnTe, InP, InAs, InGaP, and CuInS₂, but the present invention is not limited thereto. Among these, CdSe, CdTe, InP, InGaP, or CuInS₂ is preferable from the viewpoint of emitting visible light with high efficiency. As a shell, CdS, ZnS, ZnO, GaAs, and a complex thereof can be used, but the present invention is not limited thereto. The emission wavelength of the quantum dots can be typically adjusted by adjusting the composition of particles and the size of particles.

The quantum dots may be added to the polymerizable composition in the form of particles or in the form of a dispersion in which they are dispersed in a solvent. It is preferable that the quantum dots are added in the form of a dispersion from the viewpoint of suppressing aggregation of particles of the quantum dots. The solvent used herein is not particularly limited. For example, 0.01 parts by mass to 10 parts by mass of the quantum dots can be added to the quantum dot-containing curable composition with respect to 100 parts by mass of the total mass of the polymerizable composition.

The content of the quantum dots in the quantum dot-containing curable composition is preferably 0.01 to 10 mass % and more preferably 0.05 to 5 mass % with respect to the total mass of the curable compound in the curable composition.

<Curable Compound>

The curable compound which is included in the quantum dot-containing curable composition and forms the organic matrix 30P when cured is not particularly limited as long as it includes 30 mass % of an alicyclic epoxy compound. From the viewpoint of oxygen barrier properties, the content of the alicyclic epoxy compound in the curable compound is preferably 50 mass % or higher, more preferably 80 mass % or higher, and still more preferably 100 mass % (excluding impurities).

(Alicyclic Epoxy Compound)

The photocurable compound includes at least an alicyclic epoxy compound as a polymerizable compound. As the alicyclic epoxy compound, one kind may be used, or two or more kinds having different structures may be used. In the following description, in a case where two or more kinds having different structures are used as the alicyclic epoxy compound, the content of the alicyclic epoxy compound refers to the total content thereof. The same shall be applied to a case where two or more kinds having different structures are used as other components.

The alicyclic epoxy compound has higher curing properties by light irradiation than an aliphatic epoxy compound. It is preferable that a polymerizable compound having excellent photocuring properties is used from the viewpoints of improving productivity and forming a layer in which an irradiated portion and a non-irradiated portion have uniform properties. As a result, in the wavelength conversion member, the curling of the wavelength conversion layer can be suppressed, and the quality can be made to be uniform. In general, an epoxy compound is likely to have a reduced curing shrinkage during photocuring. This point is advantageous in forming a smooth wavelength conversion layer having a reduced deformation.

The alicyclic epoxy compound includes at least one alicyclic epoxy group. Here, the alicyclic epoxy group refers to a monovalent substituent having a condensed ring of an epoxy ring and a saturated hydrocarbon ring and preferably a monovalent substituent having a condensed ring of an epoxy ring and a cycloalkane ring. Preferable examples of the alicyclic epoxy compound include a compound having one or more structures shown below in one molecule, in which an epoxy ring and a cyclohexane ring are condensed.

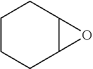

The number of the structures included in one molecule may be two or more and is preferably one or two.

In addition, the structure may include one or more substituents. Examples of the substituent include an alkyl group (for example, an alkyl group having 1 to 6 carbon atoms), a hydroxyl group, an alkoxy group (for example, an alkoxy group having 1 to 6 carbon atoms), and a halogen atom (for example, a fluorine atom, a chlorine atom, or a bromine atom), a cyano group, an amino group, a nitro group, an acyl group, and a carboxyl group. The structure may have the above-described substituent but is preferably unsubstituted.

In addition, the alicyclic epoxy compound may include a polymerizable functional group other than the alicyclic epoxy group. The polymerizable functional group refers to a functional group which can cause a polymerization reaction to occur by radical polymerization or cationic polymerization, and examples thereof include a (meth)acryloyl group.

Preferable examples of a commercially available product of the alicyclic epoxy compound include: CELLOXIDE (registered trade name) 2000, CELLOXIDE 2021P, CELLOXIDE 3000, CELLOXIDE 8000, CYCLOMER (registered trade name) M100, EPOLEAD GT 301, and EPOLEAD GT 401 (all of which are manufactured by Daicel Corporation); 4-vinylcyclohexene dioxide (manufactured by Sigma-Aldrich Co., LLC.); D-limonene oxide (manufactured by Nippon Terpene Chemicals, Inc.); and SANSOCIZER (registered trade name) E-PS (manufactured by New Japan Chemical Co., Ltd.). Among these, one kind can be used alone, or two or more kinds can be used in combination.

From the viewpoint of improving adhesiveness between the wavelength conversion layer and a layer adjacent thereto, the following alicyclic epoxy compound I or II is more preferable. As a commercially available product of the alicyclic epoxy compound I, CELLOXIDE 2021P (manufactured by Daicel Corporation) can be used. As a commercially available product of the alicyclic epoxy compound II, CYCLOMER M100 (manufactured by Daicel Corporation) can be used.

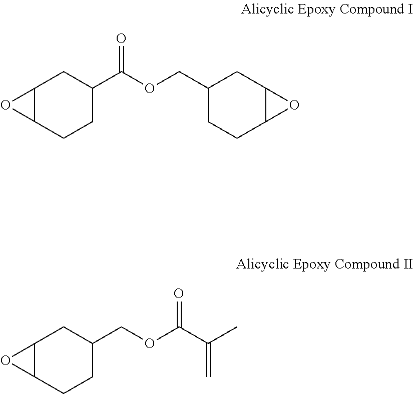 [SMILES: O=C(OCC1CCC2OC2C1)C1CCC2OC2C1 ; C=C(C)C(=O)OCC1CCC2OC2C1]

In addition, the alicyclic epoxy compound can also be synthesized using a well-known method. A method of preparing the alicyclic epoxy compound is not particularly limited. For example, the alicyclic epoxy compound can be synthesized with reference to “The Fourth Series of Experimental Chemistry, 20 Organic Synthesis II, pp. 213˜(Maruzen-Yushodo Co., Ltd., 1992), “The Chemistry of Heterocyclic Compounds—Small Ring Heterocycles, Part 3 Oxiranes” (Ed. by Alfred Hasfner, John Wiley and Sons, An Interscience Publication, New York, 1985), “Adhesion, Vol. 29, No. 12, 32” (Yoshimura, 1985), “Adhesion, Vol. 30, No. 5, 42” (Yoshimura, 1986), “Adhesion, Vol. 30, No. 7, 42” (Yoshimura, 1986), JP1999-100378A (JP-H11-100378A), and JP2926262B.

((Curable Compound which can be Used in Combination with Alicyclic Epoxy Compound))

The curable compound may include one or more other polymerizable compounds (curable compounds) in addition to one or more alicyclic epoxy compounds. As the other polymerizable compounds, a (meth)acrylate compound such as a monofunctional (meth)acrylate compound or a polyfunctional (meth)acrylate compound, an oxirane compound, or an oxetane compound is preferable. In the present invention and this specification, a (meth)acrylate compound or (meth)acrylate represents a compound having one or more (meth)acryloyl groups in one molecule, and a (meth)acryloyl group represents either or both of an acryloyl group and a methacryloyl group.

The oxirane compound is also called ethylene oxide, and representative examples thereof include a functional group called a glycidyl group. In addition, the oxetane compound is a 4-membered cyclic ether. By using this polymerizable compound, for example, the (meth)acrylate compound in combination with the alicyclic epoxy compound, the (meth)acrylate compound and a polymer of the alicyclic epoxy compound forms an interpenetrating polymer network (IPN), and a polymer can be designed so as to exhibit desired mechanical properties and optical properties. In addition, the oxirane compound or the oxetane compound is copolymerizable with the alicyclic epoxy compound, and a polymer can be designed so as to exhibit desired mechanical properties and optical properties. In addition, by using these compounds in combination, the viscosity of the composition before curing, the dispersibility of the quantum dots, and the solubility of a photopolymerization initiator described below and other additives can also be adjusted.

In addition, the content of the curable compound including an alicyclic epoxy compound is preferably 10 to 99.9 mass %, more preferably 50 to 99.9 mass %, and still more preferably 92 to 99 mass % with respect to 100 mass % of the total amount of the quantum dot-containing curable composition.

(Adherence Agent)

It is preferable that the adherence agent 40b included in the curable composition is a compound which is bondable to the adherence agent 40B included in the intermediate layer 12b when the curable composition is cured to form the wavelength conversion layer 30. As a preferable example of the adherence agent 40b, a monomer component which is polymerizable or copolymerizable with the adherence agent 40B in the wavelength conversion layer 30 is preferable. For example, by forming glycidyl methacrylate using the adherence agent 40b included in the curable composition and the adherence agent 40B included in the curable composition forming the wavelength conversion layer 30 as described below in Example 6, polyglycidyl methacrylate in which the wavelength conversion layer 30 and the intermediate layer 12b are bonded to each other is formed.

The addition amount of the adherence agent can be adjusted and is preferably as low as possible in a range where the effect of improving adhesiveness can be sufficiently obtained. Specifically, the addition amount of the adhesive is preferably 0.1 mass % to 10 mass %, more preferably 0.5 mass % to 8 mass %, and still more preferably 1 mass % to 5 mass % with respect to the total mass of the wavelength conversion layer.

(Polymerization Initiator)

It is preferable that the quantum dot-containing curable composition includes a polymerization initiator. As the polymerization initiator, a polymerization initiator which is preferable depending on the kind of the curable compound in the quantum dot-containing curable composition is preferably used, and a photopolymerization initiator is more preferably used. The photopolymerization initiator is a compound which is decomposed by light exposure to form an initiating species such as a radical or an acid. This compound can initiate and promote a polymerization reaction of the polymerizable compound using the initiating species.

The alicyclic epoxy compound is a cationically polymerizable compound. Therefore, it is preferable that the curable composition includes one or two or more photocationic polymerization initiators as the photopolymerization initiator. The details of the photocationic polymerization initiator can be found in, for example, paragraphs “0019” to “0024” of JP4675719. The content of the photocationic polymerization initiator is preferably 0.1 mol % or higher and more preferably 0.5 mol % to 5 mol % with respect to the total amount of the polymerizable compound included in the curable composition. It is preferable that an appropriate amount of the polymerization initiator is used from the viewpoints of reducing the light irradiation dose required for curing and uniformly curing the entire portion of the wavelength conversion layer.

Preferable examples of the photocationic polymerization initiator include an iodonium salt compound, a sulfonium salt compound, a pyridinium salt compound, and a phosphonium salt compound. Among these, an iodonium salt compound or a sulfonium salt compound is preferable from the viewpoint of obtaining excellent thermal stability, and an iodonium salt compound is more preferable from the viewpoint of suppressing absorption of light emitted from a light source of the wavelength conversion layer.

The iodonium salt compound is a salt which is formed using a cation site having I⁺ in a structure thereof and an anion site having an arbitrary structure. It is preferable that the iodonium salt compound is a diaryl iodonium salt having three or more electron-donating groups at least one of which is an alkoxy group. By introducing an alkoxy group which is an electron-donating group into a diaryl iodonium salt, for example, decomposition caused by water or a nucleophilic agent over time, or electron transfer caused by heat can be suppressed. As a result, improvement in stability can be expected. Specific examples of the iodonium salt compound having the above-described structure include the following photocationic polymerization initiators (iodonium salt compounds) A and B.

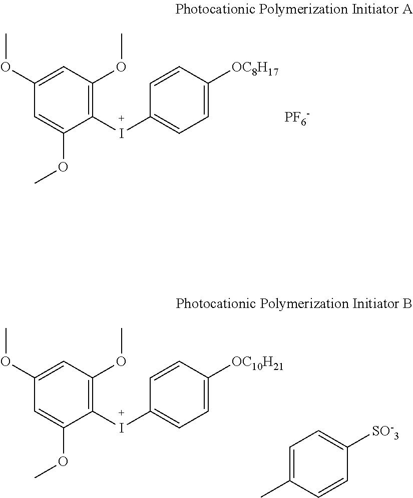

As described above, irrespective of whether or not the iodonium salt compound is used, the absorption of light emitted from a light source of the wavelength conversion layer 30 can be reduced, for example, by reducing the content of the alicyclic epoxy compound and using the (meth)acrylate compound in combination with the alicyclic epoxy compound. Therefore, the photocationic polymerization initiator which can be added to the curable composition is not limited to the iodonium salt compound. Examples of the photocationic polymerization initiator which can be used include one kind or a combination of two or more kinds selected from the following commercially available products including: CPI-110P (the following photocationic polymerization initiator C), CPI-101A, CPI-110P, and CPI-200K (all of which are manufactured by San-Apro Ltd.); WPI-113, WPI-116, WPI-124, WPI-169, and WPI-170 (all of which are manufactured by Wako Pure Chemical Industries, Ltd.); PI-2074 (manufactured by Rhodia); and IRGACURE (registered trade name) 250, IRGACURE 270, and IRGACURE 290 (the following photocationic polymerization initiator D) (all of which are manufactured by BASF SE).

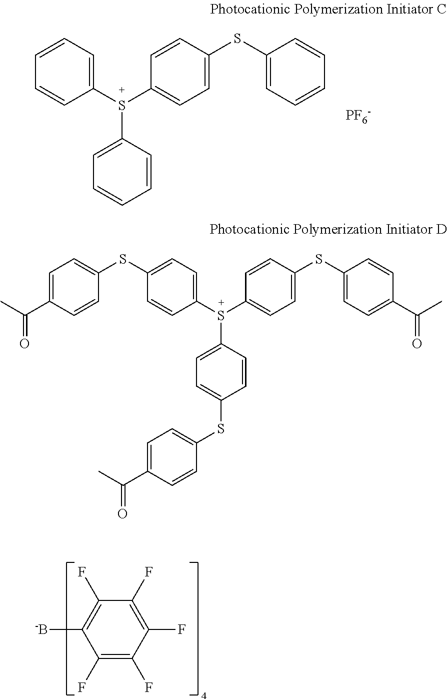

In addition, in a case where the curable composition includes a radically polymerizable compound, the curable composition may include one radical polymerization initiator or two or more radical polymerization initiators. As the radical polymerization initiator, a photoradical polymerization initiator is preferable. The details of the photoradical polymerization initiator can be found in paragraph “0037” of JP2013-043382A and paragraphs “0040” to “0042” of JP2011-159924A. The content of the photoradical polymerization initiator is preferably 0.1 mol % or higher and more preferably 0.5 mol % to 5 mol % with respect to the total mass of the polymerizable compound included in the quantum dot-containing polymerizable composition.

(Viscosity Adjuster)

Optionally, the curable composition may include a viscosity adjuster. It is preferable that the viscosity adjuster is a filler having a particle size of 5 nm to 300 nm. In addition, it is preferable that the viscosity adjuster is a thixotropic agent. In the present invention and this specification, thixotropy refers to a property in which the viscosity of a liquid composition decreases along with an increase in shear rate, and the thixotropic agent refers to a material which has a function of imparting thixotropy to a liquid composition when added to the liquid composition. Specific examples of the thixotropic agent include fumed silica, alumina, silicon nitride, titanium dioxide, calcium carbonate, zinc oxide, talc, mica, feldspar, kaolinite (kaolin clay), pyrophyllite (pyrophyllite clay), sericite, bentonite, smectite and vermiculite (for example, montmorillonite, beidellite, nontronite, or saponite), organic bentonite, and organic smectite.

In an aspect, the viscosity of the curable composition is preferably 3 to 100 mPa·s at a shear rate of 500 s⁻¹ and is preferably 300 mPa·s at a shear rate of 1 s⁻¹. It is preferable that a thixotropic agent is used to adjust the viscosity as described above. The reason why the viscosity of the curable composition is preferably 3 to 100 mPa·s at a shear rate of 500 s⁻¹ and is preferably 300 mPa·s at a shear rate of 1 s⁻¹ is as follows.

Examples of a method of manufacturing the wavelength conversion member include a manufacturing method described below including a step of forming the wavelength conversion layer by applying the curable composition to the barrier film 10, laminating and adhering the barrier film 20 to a coating film of the curable composition, and curing the curable composition. In this manufacturing method, it is preferable that the curable composition is uniformly applied to the barrier film 10 so as not to form coating streaks such that the thickness of the coating film is uniform. To that end, from the viewpoints of coating properties and leveling properties, it is preferable that the viscosity of the coating solution (curable composition) is low. On the other hand, in order to uniformly adhere the barrier film 20 to the coating film formed on the barrier film 10, it is preferable that a resistance force against a pressure during adhering is high. From this viewpoint, it is preferable that the viscosity of the coating solution is high.

The shear rate of 500 s⁻¹ is a representative value of a shear rate applied to the coating solution which is applied to the barrier film 10. The shear rate of 1 s⁻¹ is a representative value of a shear rate applied to the coating solution immediately before adhering the barrier film 20 to the coating film. The shear rate of 1 s⁻¹ is merely a representative value. In a case where the barrier film 10 and the coating solution 20 are transported at the same rate when the barrier film 20 is adhered to the coating film formed on the barrier film 10, the shear rate applied to the coating solution is substantially 0 s⁻¹. In the actual manufacturing step, the shear rate applied to the coating solution is not limited to 1 s⁻¹. The shear rate of 500 s⁻¹ is merely a representative value. In the actual manufacturing step, the shear rate applied to the coating solution is not limited to 500 s⁻¹. From the viewpoint of uniform coating and adhering, it is preferable that the viscosity of the curable composition is 3 to 100 mPa·s at 500 s⁻¹ which is the representative value of the shear rate applied to the coating solution when the coating solution is applied to the barrier film 10 and that the viscosity of the curable composition is 300 mPa·s or higher at 1 s⁻¹ which is the representative value of the shear rate applied to the coating solution immediately before adhering the barrier film 20 to the coating solution applied to the barrier film 10.

(Solvent)

Optionally, the curable composition may include a solvent. In this case, the kind and addition amount of the solvent used are not particularly limited. For example, as the solvent, one organic solvent or a mixture of two or more organic solvents may be used.

(Other Additives)

Optionally, the curable composition may include other functional additives. Examples of the other functional additives include a leveling agent, an antifoaming agent, an antioxidant, a radical scavenger, a water gettering agent, an oxygen gettering agent, a UV absorber, a visible light absorber, an IR absorber, a dispersing auxiliary agent for assisting dispersion of a phosphor, a plasticizer, a brittleness improver, an antistatic agent, an antifouling agent, a filler, an oxygen permeability reducing agent for reducing the oxygen permeability of the wavelength conversion layer, a refractive index regulator, and a light scattering agent.

[Barrier Film] The barrier films 10 and 20 are films having a function of suppressing permeation of water and/or oxygen. In the embodiment, the barrier layers 12a and 22a are provided on the substrates 11 and 21, respectively. In this configuration, due to the presence of the substrates, the strength of the wavelength conversion member 1D is improved, and the films can be easily manufactured.

In the wavelength conversion members according to the embodiment, the barrier films 10 and 20 in which the barrier layers 12a and 22a are supported by the substrates 11 and 21 are provided such that the barrier layers 12a and 22a are adjacent to opposite main surfaces of the wavelength conversion layer 30. However, the barrier layers 12a and 22a are not necessarily supported by the substrates 11 and 21. In addition, in a case where the substrates 11 and 21 have sufficient barrier properties, the barrier layers may include only the substrates 11 and 21.

In addition, it is preferable that the barrier films 10 and 20 are provided on opposite surfaces of the wavelength conversion layer 30 as in the embodiment. However, the barrier films 10 and 20 may be provided on only a single surface of the wavelength conversion layer 30.

The total light transmittance of the barrier film in the visible range is 80% or higher and more preferably 90% or higher. The visible range refers to a wavelength range of 380 nm to 780 nm, and the total light transmittance refers to an average light transmittance value in the visible range.

The oxygen permeability of the barrier films 10 and 20 is preferably 1.00 cm³/(m²·day·atm) or lower. The oxygen permeability of the barrier films 10 and 20 is more preferably 0.10 cm³/(m²·day·atm) or lower, and still more preferably 0.01 cm³/(m²·day·atm) or lower.

The barrier films 10 and 20 have not only a gas barrier function of blocking oxygen but also a function of blocking water (water vapor). In the wavelength conversion member 1D, the moisture permeability (water vapor transmission rate) of the barrier film 10 and 20 is 0.10 g/(m²·day·atm) or lower. The moisture permeability of the barrier film 10 and 20 is preferably 0.01 g/(m²·day·atm) or lower.

<Substrate>

In the wavelength conversion member 1D, at least one main surface of the wavelength conversion layer 30 is supported by the substrate 11 or 21. Here, “main surface” refers to a surface (a front surface or a rear surface) of the wavelength conversion layer which is disposed on a visible side or a backlight side when the wavelength conversion member is used. The same can also be applied to main surfaces of other layers and members. As in the embodiment, it is preferable that front and rear main surfaces of the wavelength conversion layer 30 are supported by the substrates 11 and 21.

From the viewpoints of impact resistance and the like of the wavelength conversion member, the average thickness of the substrates 11 and 21 is preferably 10 μm to 500 μm, more preferably 20 μm to 400 μm, and still more preferably 30 μm to 300 μm. In a configuration where the retroreflection of light is increased as in a case where the concentration of the quantum dots 30A and 30B in the wavelength conversion layer 30 is reduced or a case where the thickness of the wavelength conversion layer 30 is reduced, it is preferable that the absorbance of light at a wavelength of 450 nm is low. Therefore, from the viewpoint of suppressing a decrease in brightness, the average thickness of the substrates 11 and 21 is preferably 40 μm or less and more preferably 25 μm or less.

In order to further reduce the concentration of the quantum dots 30A and 30B in the wavelength conversion layer 30 or to further reduce the thickness of the wavelength conversion layer 30, it is necessary that the number of times where the excitation light passes through the wavelength conversion layer is increased by providing means for increasing retroreflection of light, for example, a plurality of prism sheets in the retroreflecting member 2B of the backlight unit to maintain a display color of an LCD. Accordingly, it is preferable that the substrate is a transparent substrate which is transparent to visible light. Here, “transparent to visible light” represents that the light transmittance in the visible range is 80% or higher and preferably 85% or higher. The light transmittance used as an index for transparency can be measured using a method described in JIS-K 7105. That is, using an integrating sphere light transmittance measuring device, the total light transmittance and the scattered light amount are measured, and the diffuse transmittance is subtracted from the total light transmittance to obtain the light transmittance. The details of the substrate can be found in paragraphs “0046” to “0052” of JP2007-290369A and paragraphs “0040” to “0055” of JP2005-096108A.

In addition, the in-plane retardation Re(589) of the substrates 11 and 21 at a wavelength of 589 nm is preferably 1000 nm or lower, more preferably 500 nm or lower, and still more preferably 200 nm or lower.

When whether or not foreign matter or defects are present is inspected after the preparation of the wavelength conversion member 1D, foreign matter or defects can be easily found by disposing two polarizing plates at extinction positions and inserting the wavelength conversion member between the two polarizing plates to observe the wavelength conversion member. In a case where Re(589) of the substrate is in the above-described range, foreign matter or defects can be easily found during the inspection using the polarizing plates, which is preferable.

Here, Re(589) is measured using KOBRA 21ADH or WR (manufactured by Oji Scientific Instruments Co., Ltd.) by causing light at a wavelength of 589 nm to be incident in a film normal direction. The measurement wavelength λ nm can be selected by manually changing a wavelength selective filter or changing a measured value using a program or the like.

As the substrates 11 and 21, a substrate having barrier properties against oxygen and water is preferable. Preferable examples of the substrate include a polyethylene terephthalate film, a film which includes a polymer having a cyclic olefin structure, and a polystyrene film.

<Barrier Layer>

The substrates 11 and 21 include the barrier layers 12a and 22a that are formed adjacent to surfaces on the wavelength conversion layer 30 side, respectively. As described above, the barrier layers 12a and 22a are inorganic layers including silicon nitride and/or silicon oxynitride as a major component. It is preferable that the barrier layers 12a and 22a include silicon nitride as a major component.

A method of forming the barrier layer 12a or 22a is not particularly limited. For example, various film forming methods in which a film forming material can be evaporated or scattered to be deposited on a deposition target surface can be used.

Examples of the method of forming the barrier layer include a physical vapor deposition (PVD) method such as a vacuum deposition method, an oxidation deposition method, a sputtering method, or an ion plating method and a chemical vapor deposition (CVD) method.

The thickness of the barrier layer 12a or 22a may be 1 nm to 500 nm and is preferably 5 nm to 300 nm and more preferably 10 nm to 150 nm. By adjusting the thickness of the barrier layer adjacent to the wavelength conversion layer 30 to be in the above-described range, light absorption in the barrier layer can be suppressed while realizing excellent barrier properties, and the wavelength conversion member having a high light transmittance can be provided.

FIG. 2 shows the aspect where the barrier layers 12a and 22a are directly provided on the respective substrates. However, another inorganic layer or organic layer or a plurality of other inorganic layers or organic layers may be provided between the barrier layers 12a and 22a and the respective substrates within a range where the light transmittance of the wavelength conversion member does not excessively decrease.

The inorganic layer which may be provided between the barrier layers 12a and 22a and the respective substrates is not particularly limited, and various inorganic compounds such as a metal, an inorganic oxide, an inorganic nitride, or an inorganic oxynitride can be used. As an element constituting the inorganic material, silicon, aluminum, magnesium, titanium, tin, indium, or cerium is preferable. The inorganic material may include one element or two or more elements among the above elements. Specific examples of the inorganic compound include silicon oxide, silicon oxynitride, aluminum oxide, magnesium oxide, titanium oxide, tin oxide, an indium oxide alloy, silicon nitride, aluminum nitride, and titanium nitride. In addition, as the inorganic barrier layer, a metal film such as an aluminum film, a silver film, a tin film, a chromium film, a nickel film, or a titanium film may be provided. In a case where the inorganic layer is formed of silicon nitride or silicon oxynitride, the composition thereof is different from those of the barrier layers 12a and 22a.

The details of the barrier layer can be found in JP2007-290369A, JP2005-096108A, and US2012/0113672A1.

[Intermediate Layer] As described above, the matrix 12P of the intermediate layer 12b (22b) includes a chemical structure A which is bonded to silicon nitride and/or silicon oxynitride as a major component of the barrier layer 12a (22a) and a chemical structure B which is bonded to the organic matrix 30P (FIGS. 2 and 3A to 3D).

The matrix 12P of the intermediate layer 12b (22b) is not particularly limited and is preferably an organic matrix and more preferably a polymer matrix. In a case where the matrix 12P is an organic matrix or a polymer matrix, the matrix 12P can function as a barrier coating layer which covers the barrier layer 12a (22a) to improve scratch resistance of the barrier layer.

As the organic matrix which functions as the barrier coating layer, a polymer matrix including an epoxy resin and/or an acrylic resin is preferable. For example, a urethane acrylate resin used in Examples below, or a polymer obtained by polymerization of a polymerizable compound having an ethylenically unsaturated bond at a terminal or a side chain is preferably used. The urethane acrylate resin refers to a graft copolymer in which an acrylic polymer is positioned at a main chain and at least either a urethane polymer having an acryloyl group at a terminal or a urethane oligomer having an acryloyl group at a terminal is positioned at a side chain. Examples of the polymerizable compound having an ethylenically unsaturated bond at a terminal or a side chain include a (meth)acrylate compound, an acrylamide compound, a styrene compound, and maleic anhydride. Among these, a (meth)acrylate compound is preferable, and an acrylate compound is more preferable.

As the (meth)acrylate compound, for example, (meth)acrylate, urethane (meth)acrylate, polyester (meth)acrylate, or epoxy (meth)acrylate is preferable. As the styrene compound, for example, styrene, α-methylstyrene, 4-methylstyrene, divinylbenzene, 4-hydroxystyrene, or 4-carboxystyrene is preferable.

As the (meth)acrylate compound, specifically, for example, a compound described in paragraphs “0024” to “0036” of JP2013-43382A or paragraphs “0036” to “0048” of JP2013-43384A can be used.

From the viewpoint of barrier properties, the details of the barrier coating layer can be found in paragraphs “0020” to “0042” of JP2007-290369A and paragraphs “0074” to “0105” of JP2005-096108A. It is preferable that the barrier coating layers 12b and 22b include a cardo polymer from the viewpoint of adhesiveness with the barrier layers 12a and 22a. By using a cardo polymer as the organic matrix 12P of the barrier coating layers 12b and 22b, higher barrier properties can be realized. The details of the cardo polymer can be found in paragraphs “0085” to “0095” of JP2005-096108A and the description of the organic barrier layer of US2012/0113672A1.

In a case where a urethane acrylate resin used in Examples described below is used as the polymerizable composition for forming the intermediate layer, the polymerizable composition may include additives such as a monomer, an oligomer, or a polymer other than the urethane acrylate resin. The additive may be a polymerizable compound or a non-polymerizable compound. Examples of the additive include the above-described polymerizable compounds, polyester, an acrylic polymer, a methacrylic polymer, a methacrylic acid-maleic acid copolymer, polystyrene, a transparent fluororesin, polyimide, fluorinated polyimide, polyamide, polyamide imide, polyether imide, cellulose acylate, a urethane polymer, polyether ether ketone, polycarbonate, alicyclic polyolefin, polyarylate, polyethersulfone, polysulfone, fluorene ring-modified polycarbonate, alicyclic modified polycarbonate, fluorene ring-modified polyester, and an organic silicon polymer such as polysiloxane. Among these, the above-described polymerizable compounds, an acrylic polymer, or a urethane polymer is preferable. As the polymerizable compound, the (meth)acrylate compound is preferable.

The thickness of the intermediate layer (barrier coating layer) 12b (22b) is preferably in a range of 0.05 μm to 10 μm, more preferably in a range of 0.5 μm to 10 μm, and still more preferably in a range of 1 μm to 5 μm.

A method of forming the intermediate layer (barrier coating layer) 12b (22b) is not particularly limited. The intermediate layer (barrier coating layer) 12b (22b) may be formed by applying a raw material solution of the intermediate layer to the barrier layer using a coating method, may be adhered or pressure-bonded to the surface of the barrier layer using a pressure sensitive adhesive or the like, or may be formed on the barrier layer using a vapor deposition method.

In particular, it is preferable that the intermediate layer 12b (22b) is formed using a coating method. The raw material solution of the intermediate layer 12b (22b) used for coating may be a raw material solution including the adherence agent 40A which is bondable to silicon nitride and/or silicon oxynitride and the adherence agent 40B which is bondable to the organic matrix 30P, or a raw material solution including the adherence agent 40AB which is bondable to silicon nitride and/or silicon oxynitride and is bondable to the organic matrix 30P. In a case where the matrix 12P and the adherence agent does not form a bond, it is preferable that the raw material solution includes a raw material of the matrix 12P separately.

In a case where the raw material solution includes the adherence agent 40A, 40B, or 40AB which forms a chemical bond with the matrix 12P of the intermediate layer 12b (22b), the raw material solution may include a raw material of the matrix 12P separately, or the adherence agent itself may form the matrix 12P.

A method of applying the raw material solution of the intermediate layer 12b (22b) to the barrier layer is not particularly limited, and various well-known coating methods described below in the item of the manufacturing method can be used. A method of curing the coating film is not particularly limited, and photocuring, thermal curing, drying (air drying), or the like can be used.

The coating film may be cured immediately after the formation. Alternatively, the coating film may be half-cured first to form a half-cured film on the wavelength conversion layer first, and then finally cured during the curing of the wavelength conversion layer.

The preferable aspects (the first to fifth aspects) of the intermediate layers 12b and 22b are as described above. The adherence agents 40A, 40B, and 40AB included in the intermediate layers 12b and 22b will be described below.

(Adherence Agent)

The chemical structures A to D which are formed by the adherence agents 40A, 40B, and 40AB are as described above. Hereinafter, specific examples of the adherence agents forming the chemical structures A to D will be described.

—Adherence Agent 40A—

The adherence agent 40A is an adherence agent shown in FIGS. 2, 3A, and 3B which forms the chemical structure A (or can form the chemical structure A) by being bonded to silicon nitride and/or silicon oxynitride as a major component of the barrier layers 12a and 22a. As described above, preferable examples of the chemical structure A which forms a covalent bond with silicon nitride and/or silicon oxynitride as a major component of the barrier layers 12a and 22a include a structure which forms a siloxane bond with silicon nitride and/or silicon oxynitride. Preferable examples of the compound (the adherence agent 40A) which can form a siloxane bond with silicon nitride and/or silicon oxynitride include an alkoxysilane compound which is generally called a silane coupling agent.

In a case where the composition which forms the intermediate layers (barrier coating layers) 12b and 22b when cured includes an alkoxysilane compound as the adherence agent 40A, the alkoxysilane compound forms a siloxane bond with silicon nitride and/or silicon oxynitride as a major component of a surface of the barrier layers 12a and 22a or a major component of the barrier layers 12a and 22a through a hydrolysis reaction or a condensation reaction. Therefore, a covalent bond is formed between the intermediate layers (barrier coating layers) 12b and 22b and the barrier layers 12a and 22a, and adhesiveness therebetween can be improved.

Further, in a case where a reactive functional group such as a radically polymerizable group is included as the alkoxysilane compound, this radically polymerizable group and the organic matrix 12P which forms the intermediate layers 12b and 22b can form a covalent bond so as to form a structure which is bonded to the organic matrix 12P as a part of a main chain of the polymer of the polymer matrix, or a structure (chemical structure C) which is bonded to the organic matrix 12P as a side chain or a side group of the polymer of the polymer matrix. With the above-described configuration, adhesiveness between the intermediate layers 12b and 22b and the barrier layers 12a and 22a can be further improved. As the adherence agent 40A, an acrylic silane coupling agent (for example, manufactured by Shin-Etsu Chemical Co., Ltd.) or a methacrylic silane coupling agent such as trimethoxysilylpropyl methacrylate is preferable. As the alkoxysilane compound, a well-known silane coupling agent can be used without any particular limitation.

In addition, in a case where the alkoxysilane compound which can form a hydrogen bond with the organic matrix 12P of the intermediate layers 12b and 22b so as to form the chemical structure C is used, the effect of improving adhesiveness can be obtained.

In addition, as the chemical structure A which forms a hydrogen bond with silicon nitride and/or silicon oxynitride as a major component of the barrier layers 12a and 22a, as described above, a structure which forms a hydrogen bond with silicon nitride and/or silicon oxynitride as a major component of the barrier layers based on at least one of an amino group, a mercapto group, or a urethane structure is preferable. Examples of the compound (the adherence agent 40A) which can form the chemical structure C and the chemical structure A include an acrylic monomer or a methacrylic monomer having a urethane structure such as urethane acrylate in a repeating unit. Specific examples of the compound include a phenyl glycidyl ether acrylate hexamethylene diisocyanate urethane prepolymer, a phenyl glycidyl ether acrylate toluene diisocyanate urethane prepolymer, a pentaerythritol triacrylate hexamethylene diisocyanate urethane prepolymer, a pentaerythritol triacrylate toluene diisocyanate urethane prepolymer, a pentaerythritol triacrylate isophorone diisocyanate urethane prepolymer, and a dipentaerythritol pentaacrylate hexamethylene diisocyanate urethane prepolymer.

—Adherence Agent 40B—

The adherence agent 40B is an adherence agent shown in FIGS. 2, 3A, and 3B which forms the chemical structure B (or can form the chemical structure B) by being bonded to the organic matrix 30P of the wavelength conversion layer 30. As described above, as the chemical structure B which forms a covalent bond with the organic matrix 30P of the wavelength conversion layer 30, a structure which is bonded to a chemical structure of the organic matrix 30P derived from the alicyclic epoxy compound is preferable, and a structure which forms a covalent bond with the organic matrix 30P based on at least one of an amino group, a mercapto group, or an epoxy group is more preferable. It is more preferable that the chemical structure B is bonded to a chemical structure of the organic matrix 30P derived from the alicyclic epoxy compound.

Further, in a case where a reactive functional group such as a radically polymerizable group is included as the adherence agent 40B, this reactive functional group and the organic matrix 12P which forms the intermediate layers 12b and 22b can form a covalent bond so as to form a structure which is bonded to the organic matrix 12P as a part of a main chain of the polymer of the polymer matrix, or a structure (chemical structure D) which is bonded to the organic matrix 12P as a side chain or a side group of the polymer of the polymer matrix. By using the adherence agent 40B having the above-described configuration, adhesiveness between the intermediate layers 12b and 22b and the barrier layers 12a and 22a can be further improved. Examples of the adherence agent 40B include glycidyl methacrylate and an epoxy prepolymer. In addition, in a case where the adherence agent 40B which can form a hydrogen bond with the organic matrix 12P of the intermediate layers 12b and 22b so as to form the chemical structure D, for example, an acrylate group-containing epoxy polymer (for example, manufactured by KSM Co., Ltd.) is used, the effect of improving adhesiveness can be obtained.

—Adherence Agent 40AB—

The adherence agent 40AB is an adherence agent shown in FIGS. 3C and 3D which includes both the chemical structure A and the chemical structure B (or can form the chemical structure A and the chemical structure B), the chemical structure A being bonded to silicon nitride and/or silicon oxynitride as a major component of the barrier layers 12a and 22a, and the chemical structure B being bonded to the organic matrix 30P of the wavelength conversion layer 30. The preferable aspects of the chemical structures A and B and the chemical structure of the adherence agent which can form the chemical structures A and B are as described above in the items of the adherence agents 40A and 40B.

Examples of the adherence agent 40AB including both the chemical structure A which forms a covalent bond with silicon nitride and/or silicon oxynitride as a major component of the barrier layers 12a and 22a and the chemical structure B which forms a covalent bond with the organic matrix 30P of the wavelength conversion layer 30 include: aminomethoxysilane such as glycidyl trimethoxysilane (for example, manufactured by Shin-Etsu Chemical Co., Ltd.) or 3-aminopropyltrimethoxysilane; mercaptomethoxysilane such as 3-mercaptopropyltrimethoxysilane; and aminoglycidyl methacrylate such as dimethylaminoethyl glycidyl methacrylate.

Examples of the adherence agent 40AB including both the chemical structure A which forms a covalent bond with silicon nitride and/or silicon oxynitride as a major component of the barrier layers 12a and 22a and the chemical structure B which forms a hydrogen bond with the organic matrix 30P of the wavelength conversion layer 30 include: phosphoric acid acrylate such as 2-(methacryloyloxy)ethyl phosphate; amino acrylate such as dimethylaminoethyl acrylate; and butane diol (for example, SHIETSU KARENZ series).

The addition amount of the adherence agent can be appropriately set. In a case where the addition amount is excessively large, oxygen permeability is likely to increase in the matrix, and a problem such as yellowing may occur depending on the kind of the adherence agent such as an adherence agent including a thiol group. It is preferable that the addition amount is as low as possible within a range the effect of improving adhesiveness can be sufficiently obtained. Specifically, the addition amount of the adhesive is preferably 0.1 mass % to 10 mass %, more preferably 0.5 mass % to 8 mass %, and still more preferably 1 mass % to 5 mass % with respect to the total mass of the wavelength conversion layer.

[Unevenness Imparting Layer (Mat Layer)]

It is preferable that the barrier film 10 or 20 includes an unevenness imparting layer (mat layer) 13 which imparts an uneven structure to a surface of the barrier film 10 or 20 opposite to the wavelength conversion layer 30 side. In a case where the barrier film includes the mat layer, blocking properties and slipping properties of the barrier film can be improved, which is preferable. It is preferable that the mat layer is a layer including particles. Examples of the particles include inorganic particles such as silica, alumina, a metal oxide and organic particles such as crosslinked polymer particles. In addition, it is preferable that the mat layer is provided on a surface of the barrier film opposite to the wavelength conversion layer. However, the mat layer may be provided on opposite surfaces of the barrier film.

[Light Scattering Layer]

The wavelength conversion member 1D may have a light scattering function for efficiently extracting the fluorescence of the quantum dots to the outside. The light scattering function may be provided in the wavelength conversion layer 30, or a layer having a light scattering function may be separately provided as a light scattering layer.

In addition, the light scattering layer may be provided on a surface of the substrate opposite to the wavelength conversion layer. In a case where the mat layer is provided, it is preferable that the mat layer functions not only as an unevenness imparting layer but also as a light scattering layer.

[Method of Manufacturing Wavelength Conversion Member]

A method of manufacturing the wavelength conversion member according to the present invention includes:

a step of forming the barrier layers 12a and 22a on the substrates (supports) 11 and 21:

a step of forming a coating film of a raw material solution of the intermediate layer 12b by applying the raw material solution to surfaces of the barrier layers 12a and 22a, the raw material solution including an adherence agent which is bondable to silicon nitride and/or silicon oxynitride and an adherence agent which is bondable to the organic matrix 30P, or the raw material solution including an adherence agent which is bondable to silicon nitride and/or silicon oxynitride and is bondable to the organic matrix 30P;

a step of forming the intermediate layer 12b by curing the coating film;

a step of forming a coating film 30M of the curable composition by applying a quantum dot-containing curable composition including the quantum dots and an alicyclic epoxy compound to a surface of the intermediate layer 12b; and

a curing step of photocuring or thermally curing the coating film 30M.

Using this method of manufacturing the wavelength conversion member according to the present invention, the wavelength conversion member according to the present invention can be manufactured.

In the embodiment, the wavelength conversion layer 30 can be formed by applying the prepared quantum dot-containing curable composition to surfaces of the barrier films 10 and 20 and irradiating the quantum dot-containing polymerizable composition with light or heating the quantum dot-containing polymerizable composition to be cured. Examples of a coating method include various coating methods such as a curtain coating method, a dip coating method, a spin coating method, a printing coating method, a spray coating method, a slot coating method, a roll coating method, a slide coating method, a blade coating method, a gravure coating method, or a wire bar method.

Curing conditions can be appropriately set depending on the kind of the curable compound used and the composition of the polymerizable composition. In addition, in a case where the quantum dot-containing curable composition includes a solvent, a drying treatment is performed to remove the solvent before curing.

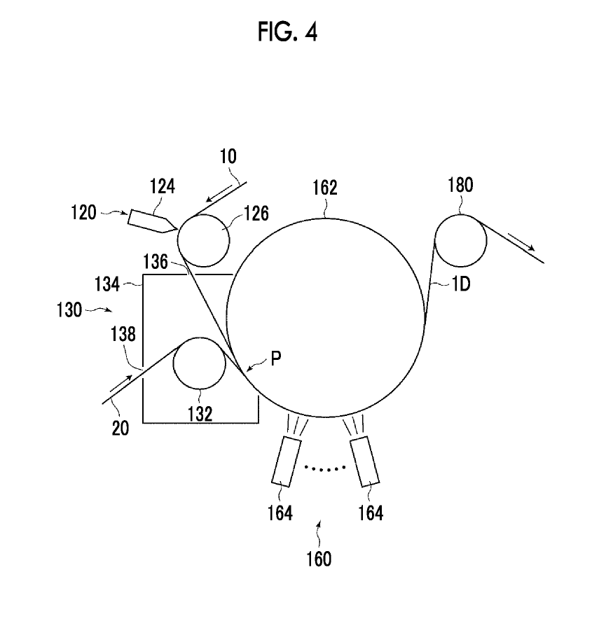

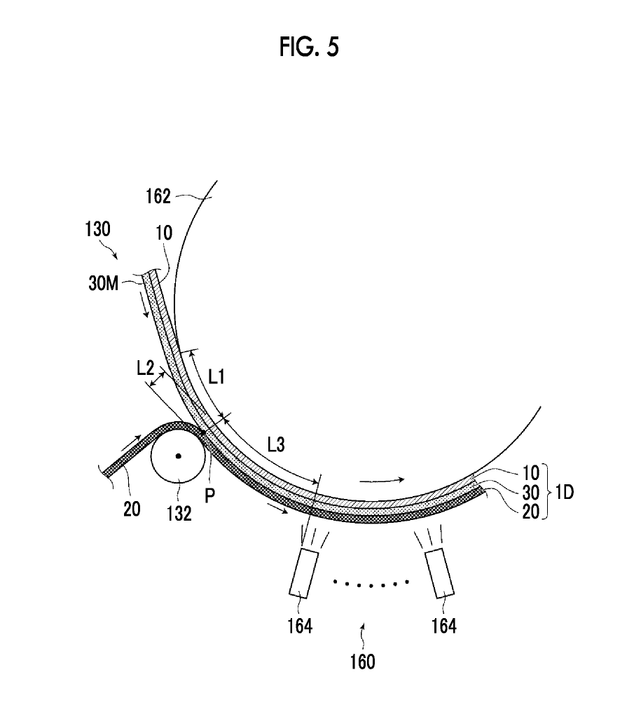

Hereinafter, the method of manufacturing the wavelength conversion member according to the present invention will be described with reference to FIGS. 4 and 5 using an example where the wavelength conversion member 1D is manufactured by photocuring in which the barrier films 10 and 20 including the barrier layers 12a and 22a and the barrier coating layers (intermediate layers) 12b and 22b on the substrates 11 and 21 are provided on opposite surfaces of the wavelength conversion layer 30. However, the present invention is not limited to the following configuration.

FIG. 4 is a diagram showing a schematic configuration of an example of a device for manufacturing the wavelength conversion member 1D. FIG. 5 is an enlarged view showing a part of the manufacturing device shown in FIG. 4. The manufacturing device shown in FIG. 4 includes: a coating portion 120 that applies the coating solution including the quantum dot-containing curable composition to the barrier film 10; a laminating portion 130 that laminates the barrier film 20 on the coating film 30M formed in the coating portion 120; and a curing portion 160 that cures the coating film 30M. In the coating portion 120, the coating film 30M is formed with an extrusion coating method using a die coater 124.

Steps of manufacturing the wavelength conversion member using the manufacturing device shown in FIGS. 4 and 5 include at least: a step of forming a coating film 30M by applying the quantum dot-containing curable composition to a surface of the first barrier film 10 (hereinafter, referred to as “first film”) which is continuously transported; a step of interposing the coating film between the first film 10 and the second barrier film 20 (hereinafter, referred to as “second film”) by laminating the second film 20, which is continuously transported, on the coating film 30M; and a step of forming the wavelength conversion layer (cured layer) by winding any one of the first film 10 and the second film 20 around a backup roller 126 in a state where the coating film 30M is interposed between the first film 10 and the second film 20, and irradiating the coating film 30M with light to be cured and polymerized while being continuously transported. In the embodiment, as the first film 10 and the second film 20, the barrier films having barrier properties against oxygen and water are used. With the above-described configuration, the wavelength conversion member 1D in which opposite surfaces of the wavelength conversion layer are protected by the barrier films can be obtained.

More specifically, first, the first film 10 is continuously transported from a transporter (not shown) to a coating portion 120. The first film 10 is transported from the transporter at a transport speed of, for example, 1 to 50 m/min. In this case, the transport speed is not limited to the above value. During the transportation, for example, a tension of 20 to 150 N/m and preferably 30 to 100 N/m is applied to the first film 10.

As described above, the first barrier film 10 and the second barrier film 20 include the barrier layers 12a and 22a and the barrier coating layers (intermediate layers) 12b and 22b on the substrates 11 and 21. The barrier films 10 and 20 can be manufactured through the following steps of: forming a coating film of the raw material solution of the intermediate layer by applying the raw material solution to the surfaces of the barrier layers 12a and 22a of the substrates 11 and 21, on which the barrier layers 12a and 22a are formed, using the coating method which is exemplified above together with the quantum dot-containing curable composition; and curing the coating film.

A method of curing the intermediate layer is not particularly limited, and the same curing method as the method of curing the coating film 30M of the wavelength conversion layer 30 can be used. In the curing step of the intermediate layer coating film, the adherence agent 40AB and/or the adherence agent 40A included in the coating film is bonded to silicon nitride and/or silicon oxynitride as a major component of the barrier layers 12a and 22a to form the chemical structure A.

The method of curing the intermediate layer can be selected depending on the composition of the intermediate layer, and examples thereof include photocuring, thermal curing, and air drying.

In the coating portion 120, the quantum dot-containing curable composition (hereinafter, also referred to as “coating solution”) is applied to a surface of the barrier coating layer (intermediate layer) 12b of the first film 10, which is continuously transported, to form a coating film 30M (refer to FIG. 4) thereon. In the coating portion 120, for example, a die coater 124 and a backup roller 126 which is disposed to face the die coater 124 are provided. A surface of the first film 10 opposite to the surface on which the coating film 30M is formed is wound around the backup roller 126, and the coating solution is applied from a jetting port of the die coater 124 to the surface of the first film 10 which is continuously transported, to form the coating film 30M thereon. Here, the coating film 30M refers to the quantum dot-containing curable composition which is applied to the first film 10 and is not cured.

In the embodiment, the die coater 124 to which an extrusion coating method is applied is used as a coating device, but the present invention is not limited thereto. For example, coating devices to which various methods such as a curtain coating method, an extrusion coating method, a rod coating method, or a roll coating method are applied can be used.

The first film 10 which has passed through the coating portion 120 and on which the coating film 30M is formed is continuously transported to a laminating portion 130. In the laminating portion 130, the second film 20 which is continuously transported is laminated on the coating film 30M such that the coating film 30M is interposed between the first film 10 and the second film 20.

In the laminating portion 130, a laminating roller 132 and a heating chamber 134 which surrounds the laminating roller 132 are provided. In the heating chamber 134, an opening 136 through which the first film 10 passes and an opening 138 through which the second film 20 passes are provided.

At a position opposite to the laminating roller 132, a backup roller 162 is disposed. The first film 10 on which the coating film 30M is formed is continuously transported to a laminating position P in a state where a surface opposite to the surface on which the coating film 30M is formed is wound around the backup roller 162. The laminating position P refers to a position where contact between the second film 20 and the coating film 30M starts. It is preferable that the first film 10 is wound around the backup roller 162 before reaching the laminating position P. The reason for this is that, even in a case where wrinkles are formed in the first film 10, the wrinkles are corrected and removed by the backup roller 162 before reaching the laminating position P. Therefore, it is preferable that a distance L1 from a position (contact position) where the first film 10 is wound around the backup roller 162 to the laminating position P is long. For example, the distance L1 is preferably 30 mm or longer, and the upper limit value thereof is typically determined based on a diameter and a pass line of the backup roller 162.

In the embodiment, the second film 20 is laminated by the backup roller 162 which is used in a curing portion 160 and the laminating roller 132. That is, the backup roller 162 which is used in the curing portion 160 also functions as a roller used in the laminating portion 130. However, the present invention is not limited to this configuration. A laminating roller other than the backup roller 162 may be provided in the laminating portion 130 such that the backup roller 162 does not function as a roller used in the laminating portion 130.

By using the backup roller 162, which is used in the curing portion 160, in the laminating portion 130, the number of rollers can be reduced. In addition, the backup roller 162 can also be used as a heat roller for heating the first film 10.

The second film 20 transported from a transporter (not shown) is wound around the laminating roller 132 and is continuously transported between the laminating roller 132 and the backup roller 162. At the laminating position P, the second film 20 is laminated on the coating film 30M formed on the first film 10 such that the barrier coating layer 22b is in contact with the coating film 30M. As a result, the coating film 30M is interposed between the first film 10 and the second film 20. Laminating described herein represents that the second film 20 is laminated on the coating film 30M.

It is preferable that a distance L2 between the laminating roller 132 and the backup roller 162 is more than the total thickness of the first film 10, the wavelength conversion layer (cured layer) 30 obtained by curing and polymerizing the coating film 30M, and the second film 20. In addition, it is preferable that L2 is equal to or less than a length obtained by adding 5 mm to the total thickness of the first film 10, the coating film 30M, and the second film 20. By adjusting the distance L2 to be equal to or less than the length obtained by adding 5 mm to the total thickness, permeation of bubbles into a gap between the second film 20 and the coating film 30M can be prevented. Here, the distance L2 between the laminating roller 132 and the backup roller 162 refers to the shortest distance between the outer circumferential surface of the laminating roller 132 and the outer circumferential surface of the backup roller 162.

Regarding the rotational accuracy of the laminating roller 132 and the backup roller 162, the radial run-out is 0.05 mm or less and preferably 0.01 mm or less. As the radial run-out decreases, the thickness distribution of the coating film 30M can be reduced.

In addition, in order to suppress thermal deformation after the coating film 30M is interposed between the first film 10 and the second film 20, a difference between the temperature of the backup roller 162 and the temperature of the first film 10 in the curing portion 160 and a difference between the temperature of the backup roller 162 and the temperature of the second film 20 are preferably 30° C. or lower, more preferably 15° C. or lower, and still more preferably 0° C.

In a case where the heating chamber 134 is provided in order to reduce the differences from the temperature of the backup roller 162, it is preferable that the first film 10 and the second film 20 are heated in the heating chamber 134. For example, hot air is supplied from a hot air blower (not shown) into the heating chamber 134 such that the first film 10 and the second film 20 can be heated.

The first film 10 may be wound around the backup roller 162 whose temperature is controlled such that the first film 10 is heated by the backup roller 162.

On the other hand, regarding the second film 20, by using a heat roller as the laminating roller 132, the second film 20 can be heated by the laminating roller 132. In this case, the heating chamber 134 and the heat roller are not essential but can be optionally provided.

Next, the coating film 30M is continuously transported to the curing portion 160 while being interposed between the first film 10 and the second film 20. In the configuration shown in the drawing, curing in the curing portion 160 is performed by light irradiation. However, in a case where the curable compound included in the quantum dot-containing curable composition is polymerizable by heating, curing can be performed by heating such as blowing of warm air. During this curing, the adherence agent 40AB and/or the adherence agent 40B included in the barrier coating layers 12b and 22b is bonded to the organic matrix 30P of the wavelength conversion layer 30 to form the chemical structure B. At this time, in a case where the coating film 30M includes the adherence agent 40b, the adherence agent 40b is bonded to the adherence agent 40AB or 40B.

At a position opposite to the backup roller 162, a light irradiating device 164 is provided. The first film 10 and the second film 20 between which the coating film 30M is interposed are continuously transported between the backup roller 162 and the light irradiating device 164. Light irradiated by the light irradiating device may be determined depending on the kind of the photocurable compound in the quantum dot-containing curable composition. For example, ultraviolet light is used. Here, the ultraviolet light refers to light in a wavelength range of 280 to 400 nm. As a light source which emits ultraviolet light, for example, a low-pressure mercury lamp, a middle-pressure mercury lamp, a high-pressure mercury lamp, an ultrahigh-pressure mercury lamp, a carbon arc lamp, a metal halide lamp, or a xenon lamp can be used. The irradiation dose may be determined in a range where the polymerization and curing reaction can be performed. For example, the coating film 30M is irradiated with ultraviolet light in an irradiation dose of 100 to 10000 mJ/cm².

In the curing portion 160, the first film 10 is wound around the backup roller 162 in a state where the coating film 30M is interposed between the first film 10 and the second film 20, and the coating film 30M is irradiated with light by the light irradiating device 164 while being continuously transported. As a result, the coating film 30M is cured to form the wavelength conversion layer (cured layer) 30.

In the embodiment, the first film 10 side is wound around the backup roller 162 and is continuously transported. However, the second film 20 may be wound around the backup roller 162 and may be continuously transported.

“Being wound around the backup roller 162” represents a state where any one of the first film 10 and the second film 20 is in contact with a surface of the backup roller 162 at a given lap angle. Accordingly, the first film 10 and the second film 20 move in synchronization with the rotation of the backup roller 162 while being continuously transported. Any one of the first film 10 and the second film 20 only has to be wound around the backup roller 162 while at least being irradiated with ultraviolet light.

The backup roller 162 includes a main body having a cylindrical shape and a rotating shaft that is disposed at opposite end portions of the main body. The main body of the backup roller 162 has a diameter φ of, for example, 200 to 1000 mm. The diameter φ of the backup roller 162 is not particularly limited. The diameter φ is preferably 300 to 500 mm from the viewpoints of curling deformation of the laminated film, facility costs, and rotational accuracy. By mounting a temperature controller on the main body of the backup roller 162, the temperature of the backup roller 162 can be controlled.

The temperature of the backup roller 162 can be determined in consideration of heat generation during the light irradiation, the curing efficiency of the coating film 30M, and the wrinkling of the first film 10 and the second film 20 on the backup roller 162. The temperature of the backup roller 162 is set to be in a temperature range of, for example, preferably 10° C. to 95° C. and more preferably 15° C. to 85° C. Here, the temperature regarding a roller refers to the surface temperature of the roller.

A distance L3 between the laminating position P and the light irradiating device 164 can be made to be, for example, 30 mm or more.

The coating film 30M is irradiated with light to form the cured layer 30, and the wavelength conversion member 1D including the first film 10, the cured layer 30, and the second film 20 is manufactured. The wavelength conversion member 1D is peeled off from the backup roller 162 by a peeling roller 180. The wavelength conversion member 1D is continuously transported to a winder (not shown) and then is wound in a roll shape by the winder.

Hereinabove, regarding the method of manufacturing the wavelength conversion member according to the present invention, the aspect where the barrier layers are provided on opposite surfaces of the wavelength conversion layer with the intermediate layer interposed therebetween has been described. However, the method of manufacturing the wavelength conversion member according to the present invention is also applicable to an aspect where the barrier layer and the intermediate layer are provided on only a single surface of the wavelength conversion layer 30. The wavelength conversion member according to this aspect can be manufactured by using a substrate not including the barrier layer as the second film.

In addition, in the description of the above-described embodiment, the barrier coating layer (intermediate layer) is formed by curing in advance on the surface of the barrier layer of the barrier film, and then the coating film of the quantum dot-containing curable composition is formed on the surface of the intermediate layer. However, the coating film of the quantum dot-containing curable composition may be formed on the intermediate layer which is not completely cured (is half-cured), and then the intermediate layer and the quantum dot-containing curable composition may be simultaneously cured.

In addition, in the description of the above-described embodiment, the intermediate layer is formed using a coating method. However, the method of forming the intermediate layer is not limited to this aspect. For example, an aspect in which the intermediate layer is adhered to the surface of the barrier layer using a pressure sensitive adhesive or the like, an aspect of the intermediate layer is pressure-bonded to the surface of the barrier layer, or an aspect where the intermediate layer is formed on the surface of the barrier layer using a vapor deposition method can be adopted.

In the manufacturing method of the wavelength conversion member, the second film 20 is laminated before curing the coating film 30M after forming the coating film 30M on the first film 10, and then the coating film 30M is cured in a state where the coating film 30M is interposed between the first film 10 and the second film 20. On the other hand, in the aspect where the barrier layer and the intermediate layer are provided on only a single surface of the wavelength conversion layer 30, the coating film 30M is formed on the first film 10 and is optionally dried and cured to form the wavelength conversion layer (cured layer). Optionally, a coating layer is formed on the wavelength conversion layer, and then the second film which is formed of a substrate not including the barrier layer is laminated on the wavelength conversion layer with an adhesive (and the coating layer) interposed therebetween. As a result, the wavelength conversion member 1D can be formed. The coating layer includes one or more other layers such as an inorganic layer and can be formed using a well-known method.

[Backlight Unit]

As described above, the backlight unit 2 shown in FIG. 1 includes: a surface light source 1C including a light source 1A, which emits primary light (blue light La), and a light guide plate 1B which guides and emits the primary light emitted from the light source 1A; a wavelength conversion member 1D that is provided on the surface light source 1C; a retroreflecting member 2B that is disposed to face the surface light source 1C with the wavelength conversion member 1D interposed therebetween; and a reflection plate 2A that is disposed to face the wavelength conversion member 1D with the surface light source 1C interposed therebetween. The wavelength conversion member 1D are excited by excitation light, which is at least a portion of the primary light L_{B} emitted from the surface light source 1C, to emit fluorescence and emits secondary light (L_{G}, L_{R}) which includes the fluorescence and the primary light L_{B} which does not function as excitation light.

From the viewpoint of realizing high brightness and high color reproducibility, it is preferable that the backlight unit includes a multi-wavelength light source. For example, it is preferable that blue light having a center emission wavelength in a wavelength range of 430 nm to 480 nm and having a full width at half maximum of emission peak of 100 nm or less, green light having a center emission wavelength in a wavelength range of 500 nm or longer and shorter than 600 nm and having a full width at half maximum of emission peak of 100 nm or less, and red light having a center emission wavelength in a wavelength range of 600 nm to 680 nm and having a full width at half maximum of emission intensity peak of 100 nm or less are emitted.

From the viewpoint of further improving brightness and color reproducibility, the wavelength range of the blue light emitted from the backlight unit 2 is preferably 430 nm to 480 nm and more preferably 440 nm to 460 nm.

From the same viewpoint, the wavelength range of the green light emitted from the backlight unit 2 is preferably 520 nm to 560 nm and more preferably 520 nm to 545 nm.

From the same viewpoint, the wavelength range of the red light emitted from the backlight unit is preferably 600 nm to 680 nm and more preferably 610 nm to 640 nm. In addition, from the same viewpoint, the full width at half maximum of the emission intensity of each of the blue light, the green light, and the red light emitted from the backlight unit is preferably 80 nm or less, more preferably 50 nm or less, still more preferably 40 nm or less, and still more preferably 30 nm or less. In particular, it is more preferable that the full width at half maximum of the emission intensity of the blue light is 25 nm or less.

The backlight unit 2 includes at least the wavelength conversion member 1D and the surface light source 1C. As the light source 1A, for example, a light source which emits blue light having a center emission wavelength in a wavelength range of 430 nm to 480 nm, or a light source which emits ultraviolet light can be used. As the light source 1A, for example, a light emitting diode or a laser light source can be used.

As shown in FIG. 1, the surface light source 1C may include: the light source 1A; and the light guide plate 1B that guides and emits the primary light emitted from the light source 1A. Alternatively, the surface light source 1C may include: the light source 1A that is disposed along with a plane parallel to the wavelength conversion member 1D; and a diffusion plate 1E that is provided instead of the light guide plate 1B. The former surface light source is called an edge light mode, and the latter surface light source is called a direct backlight mode.

In the embodiment, the example in which the surface light source is used as the light source has been described. As the light source, a light surface other than the surface light source can also be used.

(Configuration of Backlight Unit)

In the above description regarding FIG. 1, the configuration of the backlight unit is an edge light mode including a light guide plate or a reflection plate as a component. However, the configuration of the backlight unit may be a direct backlight mode. As the light guide plate, a well-known light guide plate can be used without any particular limitation.

In addition, as the reflection plate 2A, a well-known reflection plate can be used without any particular limitation. The details of the reflection plate 2A can be found in JP3416302B, JP3363565B, JP4091978B, and JP3448626B, the contents of which are incorporated herein by reference.

The retroreflecting member 2B may be formed of a well-known diffusion plate, a diffusion sheet, a prism sheet (for example, BEF series, manufactured by Sumitomo 3M Ltd.), or a light guide. The configuration of the retroreflecting member 2B can be found in JP3416302B, JP3363565B, JP4091978B, and JP3448626B, the contents of which are incorporated herein by reference.

[Liquid Crystal Display Device]

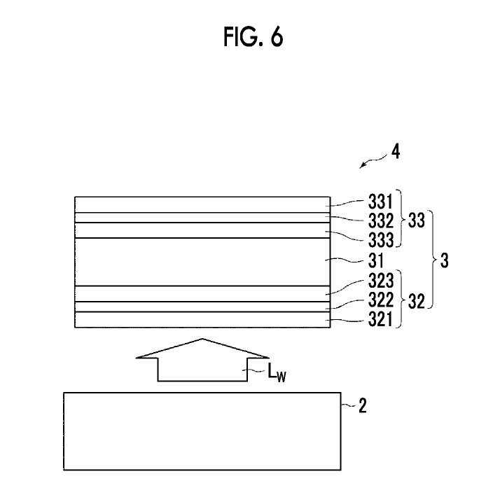

The above-described backlight unit 2 can be applied to a liquid crystal display device. As shown in FIG. 6, a liquid crystal display device 4 includes: the backlight unit 2 according to the embodiment; and a liquid crystal cell unit 3 that is disposed to face the retroreflecting member side of the backlight unit 2.

In the liquid crystal cell unit 3, as shown in FIG. 6, a liquid crystal cell 31 is interposed between polarizing plates 32 and 33. In the polarizing plates 32 and 33, opposite main surfaces of polarizers 322 and 332 are protected by polarizing plate protective films 321 and 323 and polarizing plate protective films 331 and 333, respectively.

Regarding each of the liquid crystal cell 31, the polarizing plates 32 and 33, and other components which constitute the liquid crystal display device 4, a product prepared using a well-known method or a commercially available product can be used without any particular limitation. In addition, undoubtedly, a well-known interlayer such as an adhesive layer can be provided between respective layers.

As a driving mode of the liquid crystal cell 31, various modes such as a twisted nematic (TN) mode, a super twisted nematic (STN) mode, a vertical alignment (VA) mode, an in-plane switching (IPS) mode, or an optically compensated bend (OCB) mode can be used without any particular limitation. The liquid crystal cell is preferably a VA mode, an OCB mode, an IPS mode, or a TN mode but is not limited thereto. Examples of the configuration of the VA mode liquid crystal display device include a configuration shown in FIG. 2 described in JP2008-262161A. However, a specific configuration of the liquid crystal display device is not particularly limited, and a well-known configuration can be adopted.

Optionally, the liquid crystal display device 4 further includes an optical compensation member for optical compensation or a sub-functional layer such as an adhesive layer. Further, in addition to (or instead of) a color filter substrate, a thin film transistor substrate, a lens film, a diffusion sheet, a hard coat layer, an anti-reflection layer, a low-reflection layer, or an anti-glare layer, a surface layer such as a forward scattering layer, a primer layer, an antistatic layer, or an undercoat layer may be disposed.

The backlight-side polarizing plate 32 may include a phase difference film as the polarizing plate protective film 323 on the liquid crystal cell 31 side. As this phase difference film, for example, a well-known cellulose acylate film can be used.

The backlight unit 2 and the liquid crystal display device 4 includes the wavelength conversion member according to the present invention having a small light loss. Therefore, the backlight unit 2 and the liquid crystal display device 4 exhibit the same effects as those of the wavelength conversion member according to the present invention, in which peeling at an interface of the wavelength conversion layer including quantum dots is not likely to occur, the light fastness is excellent, the brightness durability is high, and the long-term reliability of brightness is high.

### EXAMPLES

Hereinafter, the present invention will be described in detail using examples. Materials, used amounts, ratios, treatment details, treatment procedures, and the like shown in the following examples can be appropriately changed within a range not departing from the scope of the present invention. Accordingly, the scope of the present invention is not limited to the following specific examples.

1. Preparation of Barrier Film

### (Preparation of High Barrier Film)

A barrier layer was formed on a single surface of a polyethylene terephthalate film (PET film, manufactured by Toyobo Co., Ltd. trade name: COSMOSHINE (registered trade name) A4300, thickness: 50 μm) substrate in the following procedure.

First, trimethylolpropane triacrylate (TMPTA, manufactured by Daicel-Cytec Co., Ltd.) and a photopolymerization initiator (ESACURE (registered trade name) KTO 46, manufactured by Lamberti S.p.A.) were prepared and were weighed such that a mass ratio thereof was 95:5. These components were dissolved in methyl ethyl ketone. As a result, a coating solution having a solid content concentration of 15% was obtained. This coating solution was applied to the above-described PET film using a roll-to-roll method with a die coater and was allowed to pass through a drying zone at 50° C. for 3 minutes. Next, in a nitrogen atmosphere, the coating solution was irradiated with ultraviolet light (cumulative irradiation dose: about 600 mJ/cm²) to be cured, and the PET film was wound. The thickness of the organic barrier layer formed on the PET film substrate was 1 μm.

Next, the PET film with the organic barrier layer was set on a transport portion of a roll-to-roll type vacuum deposition device for vacuum evacuation, and then an inorganic barrier layer (silicon nitride layer) was formed on a surface of the PET substrate using a chemical vapor deposition (CVD) method and a CVD device.

As raw material gases, silane gas (flow rate: 160 sccm), ammonia gas (flow rate: 370 sccm), hydrogen gas (flow rate: 590 sccm), and nitrogen gas (flow rate: 240 sccm) were used. As a power supply, a high-frequency power supply having a frequency of 13.56 MHz was used. The film forming pressure was 40 Pa, and the achieved thickness was 50 nm. This way, a high barrier film in which the organic barrier layer and the inorganic barrier layer were formed in this order on the substrate was prepared. In the barrier film, the moisture permeability measured under conditions of 40° C. and 90% RH was 0.001 g/(m²·day·atm), and the oxygen permeability measured under conditions of measurement temperature: 23° C. and 90% RH was 0.02 cm³/(m²·day·atm).

(Low Barrier Film)

A polyethylene terephthalate film (PET film; trade name: COSMOSHINE (registered trade name) A4300, manufactured by Toyobo Co., Ltd.; thickness: 50 μm) was prepared as a low barrier film. The treatments of forming the barrier layer and the like were not performed. In this film, the oxygen permeability measured under conditions of measurement temperature: 23° C. and 90% RH was 20 cm³ (m²·day·atm).

2. Preparation of Quantum Dot-Containing Curable Composition

The quantum dot-containing polymerizable composition was prepared at the following composition ratio, was filtered through a filter formed of polypropylene having a pore size of 0.2 μm, and was dried under a reduced pressure for 30 minutes to prepare a coating solution according to each example. In the following description, CZ520-100 (manufactured by NN-Labs LLC.) was used as a quantum dot dispersion 1 having a maximum emission wavelength of 535 nm, and CZ620-100 (manufactured by NN-Labs LLC.) was used as a quantum dot dispersion 2 having a maximum emission wavelength of 630 nm. Here, in these quantum dots, a core was CdSe, a shell was ZnS, and a ligand was octadecylamine. The quantum dots were dispersed in toluene in a concentration of 3 wt %. In addition, the curable compound was a compound according to each example shown in Table 1.

Quantum Dot-Containing Polymerizable Composition

| | |
|---|---|
| Quantum Dot Dispersion 1 | 10 Parts by Mass |
| (Maximum Emission Wavelength: 535 nm) | |
| Quantum Dot Dispersion 2 | 1 Part by Mass |
| (Maximum Emission Wavelength: 630 nm) | |
| Curable Compound (Matrix Material) | 95 Parts by Mass |
| Photopolymerization Initiator IRGACURE 819 | 1 Part by Mass |
| (Manufactured by BASF SE) | |

In Table 1, CELLOXIDE 2021P (manufactured by Daicel Corporation) was used as an alicyclic epoxy compound I, and CELLOXIDE 8000 (manufactured by Daicel Corporation) was used as an alicyclic epoxy compound II. The curable compound used in Comparative Examples 1 and 2 was not an alicyclic epoxy compound but an aliphatic epoxy compound, which was 828US (manufactured by Mitsubishi Chemical Corporation).

3. Preparation of Wavelength Conversion Member

### Example 1

### —Preparation of Barrier Film—

A urethane acrylate resin (ACRYD 8BR 500, manufactured by Taisei Fine Chemical Co., Ltd.), a photopolymerization initiator (IRGACURE 184, manufactured by Ciba Specialty Chemicals Inc.), and an adherence agent (a mixture including the adherence agent 40A (trimethoxysilylpropyl methacrylate) and the adherence agent 40B (glycidyl methacrylate; hereinafter, abbreviated as GMA) at a mass ratio of 50:50) were weighed such that a mass ratio thereof was 94:5:1. These components were dissolved in methyl ethyl ketone. As a result, a coating solution for forming the barrier coating layer (intermediate layer) having a solid content concentration of 15% was prepared. This coating solution was applied to a surface of the barrier layer in the high barrier film using a roll-to-roll method with a die coater and was allowed to pass through a drying zone at 100° C. for 3 minutes. Next, a barrier coating layer (intermediate layer) was formed and then was rolled. As a result, a barrier film 1 according to Example 1 was prepared. The thickness of the barrier coating layer formed on the support was 1 μm.

—Preparation of Wavelength Conversion Member—

Next, the prepared quantum dot-containing polymerizable composition was applied to the surface of the barrier coating layer using a die coater while continuously transporting the barrier film 1 at 1 m/min with a tension of 60 N/m. As a result, a coating film having a thickness of 50 μm was formed. Next, the barrier film 1 in which the coating film was formed was wound around the backup roller, and another barrier film 1 was laminated on the coating film such that the barrier coating layer surface faced the coating film. Next, the laminate was allowed to pass through a heating zone at 100° C. for 3 minutes while being continuously transported in a state where the coating film was interposed between the barrier films 1. Next, the wavelength conversion layer including the quantum dots was cured by irradiating it with ultraviolet light using an air-cooled metal halide lamp (manufactured by Eye Graphics Co., Ltd.) of 160 W/cm. As a result, a wavelength conversion member was prepared. The irradiation dose of ultraviolet light was 2000 mJ/cm².

### Example 2

A wavelength conversion member was prepared using the same method as in Example 1, except that urethane acrylate (UA306H, manufactured by Kyoeisha Chemical Co., Ltd.) was used as the adherence agent 40A in the coating solution for forming the barrier coating layer.

### Example 3

A wavelength conversion member was prepared using the same method as in Example 1, except that the adherence agent 40AB (2-(methacryloyloxy)ethyl phosphate) shown in Table 1 was used without using the adherence agent 40A and the adherence agent 40B in the coating solution for forming the barrier coating layer.

### Example 4

A wavelength conversion member according to Example 4 was prepared using the same method as in Example 3, except that dimethylaminoethyl acrylate was used as the adherence agent AB in the coating solution for forming the barrier coating layer.

### Example 5

A wavelength conversion member according to Example 5 was prepared using the same method as in Example 3, except that: 3-aminopropyltrimethoxysilane was used as the adherence agent AB in the coating solution for forming the barrier coating layer; and the thickness of the barrier coating layer was 30 nm.

### Example 6

A wavelength conversion member according to Example 6 was prepared using the same method as in Example 1, except that 5 parts by mass of GMA as the adherence agent 40B included in the coating solution for forming the barrier coating layer was added to the quantum dot-containing polymerizable composition. The amount of the curable compound added to the quantum dot-containing curable composition during the addition of the adherence agent was 90 parts by mass.

### Example 7

A wavelength conversion member according to Example 7 was prepared using the same method as in Example 1, except that the alicyclic epoxy compound II was used instead of the alicyclic epoxy compound I as the curable composition in the quantum dot-containing polymerizable composition.

### Comparative Example 1

A wavelength conversion member according to Comparative Example 1 was prepared using the same method as in Example 1, except that: the high barrier film was used as it is as the barrier film without providing the barrier coating layer; and an aliphatic epoxy compound (DENACOL EX216L, manufactured by Nagase ChemteX Corporation) was used instead of the alicyclic epoxy compound I as the curable composition in the quantum dot-containing polymerizable composition.

### Comparative Example 2

A wavelength conversion member according to Comparative Example 2 was prepared using the same method as in Example 1, except that an aliphatic epoxy compound (DENACOL EX216L, manufactured by Nagase ChemteX Corporation) was used instead of the alicyclic epoxy compound I as the curable composition in the quantum dot-containing polymerizable composition.

### Comparative Example 3

A wavelength conversion member according to Comparative Example 3 was prepared using the same method as in Example 1, except that the high barrier film was used as it is as the barrier film without providing the barrier coating layer.

### Comparative Example 4

A wavelength conversion member according to Comparative Example 4 was prepared using the same method as in Example 1, except that a coating solution not including the adherence agent component and including a urethane acrylate resin (ACRYD 8BR 500, manufactured by Taisei Fine Chemical Co., Ltd.) and a photopolymerization initiator (IRGACURE (registered trade name) 184, manufactured by Ciba Specialty Chemicals Inc.) at a mass ratio of 95:5 was used as the coating solution for forming the barrier coating layer.

### Comparative Example 5

A wavelength conversion member was prepared using the same method as in Example 1, except that trimethoxysilylpropyl methacrylate was not added to the coating solution for forming the barrier coating layer. At this time, a urethane acrylate resin (ACRYD 8BR 500, manufactured by Taisei Fine Chemical Co., Ltd.) was used instead of trimethoxysilylpropyl methacrylate in an amount corresponding to the mass of trimethoxysilylpropyl methacrylate added in Example 1.

### Comparative Example 6

A wavelength conversion member was prepared using the same method as in Example 1, except that GMA was not added to the coating solution for forming the barrier coating layer. At this time, a urethane acrylate resin (ACRYD 8BR 500, manufactured by Taisei Fine Chemical Co., Ltd.) was used instead of GMA in an amount corresponding to the mass of GMA added in Example 1.

### Comparative Example 7

A wavelength conversion member was prepared using the same method as in Example 1, except that the low barrier film was used instead of the high barrier film.

4. Evaluation of Wavelength Conversion Member

The wavelength conversion member according to each example was evaluated in the following evaluation item. Table 1 shows the evaluation results.

(Evaluation of Oxygen Barrier Properties of Matrix)

Only the matrix material of the wavelength conversion layer used in Examples and Comparative Examples was applied to a substrate to form a coating film having a thickness of 100 μm, and the coating film was peeled off from the substrate. As a result, a single film was obtained. The oxygen permeability of the obtained single film was measured using an oxygen permeability measuring device (OX-TRAN 2/20 (trade name), manufactured by Mocon Inc.) under conditions of measurement temperature: 23° C. and relative humidity: 90% Based on this result, the oxygen barrier properties of the wavelength conversion member was evaluated based on the following evaluation standards.

A: 10.00 cm³/(m²·day·atm) or lower

B: higher than 10.00 cm³/(m²·day·atm) and 100.0 cm³/(m²·day·atm) or lower

C: higher than 100.0 cm³/(m²·day·atm)

(Light Fastness Evaluation)

The wavelength conversion member according to each of the Examples and Comparative Examples was cut into a rectangular shape having a size of 3 cm×3 cm. In a room held at 25° C. and 60% RH, the wavelength conversion member according to each example was placed on a commercially available blue light source (OPSM-H150X142B, manufactured by OPTEX FA Co., Ltd.), and was continuously irradiated with blue light for 100 hours.

After the continuous irradiation, an end portion of the wavelength conversion member was observed. The distance from an end portion interface of the wavelength conversion member to a boundary surface of a region in the center direction where light emission behavior was lost or light emission was attenuated was represented by d, and this value was evaluated.

### Evaluation Standards

d≦0.1 mm: A (Excellent)

0.1 mm<d≦0.5 mm: B (Good)

0.5 mm<d: C (Not Good)

(Evaluation of Brightness Durability (Brightness Deterioration))

A commercially available tablet terminal (Kindle (registered trade name) Fire HDX 7″, manufactured by Amazon.com Inc.) was disassembled to extract a backlight unit. The wavelength conversion member according to each example which was cut into a rectangular shape was placed on a light guide plate of the extracted backlight unit, and two prism sheets whose surface roughness pattern directions were perpendicular to each other were laminated thereon. The brightness of light, which was emitted from a blue light source and passed through the wavelength conversion member and the two prism sheets was measured using a brightness meter (SR3, manufactured by Topcon Corporation) provided at a distance of 740 mm perpendicular to the surface of the light guide plate. The measurement was performed at inner positions which were at a distant of 5 mm from four corners of the wavelength conversion member, and the average value (Y0) of the measured values at the four corners was set as an evaluation value.

In a room held at 25° C. and 60% RH, the wavelength conversion member according to each example was placed on a commercially available blue light source (OPSM-H150X142B, manufactured by OPTEX FA Co., Ltd.), and was continuously irradiated with blue light for 100 hours.

After the continuous irradiation, the brightness (Y1) at the four corners of the wavelength conversion member was measured using the same method as that of the evaluation of the brightness before the continuous irradiation. A change rate (ΔY) between the brightness before the continuous irradiation and the brightness after the continuous irradiation was obtained and was set as an index for brightness deterioration. The results are shown in Table 1.

ΔY=(Y0−Y1)÷Y0×100

### Evaluation Standards

ΔY<20: A (Excellent)

20≦ΔY≦30: B (Good)

30<ΔY:C (Not Good)

(Evaluation of Adhesiveness)

The 180° peeling adhesive strength of the wavelength conversion member according to each example was measured using a method described in JIS Z 0237. The adhesiveness of each example was evaluated from the measurement results based on the following evaluation standards. The obtained results are shown in Table 1.

The 180° peeling adhesive strength was 2.015 N/10 mm or higher: A (Excellent)

The 180° peeling adhesive strength was 0.5 N/10 mm or higher and lower than 2.015 N/10 mm: B (Good)

The 180° peeling adhesive strength was lower than 0.5 N/10 mm: C (Not Good) It was found from Table 1 that, in the wavelength conversion member according to each of the Examples, the adhesiveness of the intermediate layer with the wavelength conversion layer or the barrier layer was high, and the light fastness was excellent. In addition, it was found that, in a liquid crystal display device into which the wavelength conversion member according to each of the Examples was incorporated, brightness durability was high, and long-term reliability was high.

TABLE 1

| | | | Barrier Film | | | |
|---|---|---|---|---|---|---|
| | | | Adherence Agent | | | |
| | Matrix | | | | | Oxygen |
| | Curable | Adherence | | | Adherence | Barrier |
| | Compound | Agent | Adherence Agent 40AB | Adherence Agent 40A | Agent 40B | Properties |
| Example 1 | Alicyclic | — | — | Trimethoxysilylpropyl | GMA | A |
| | Epoxy | | | Methacrylate | | |
| | Compound I | | | | | |
| Example 2 | Alicyclic | — | — | Urethane Acrylate | GMA | A |
| | Epoxy | | | | | |
| | Compound I | | | | | |
| Example 3 | Alicyclic | — | 2-(Methacryloyloxy)Ethyl | — | — | A |
| | Epoxy | | Phosphate | | | |
| | Compound I | | | | | |
| Example 4 | Alicyclic | — | Dimethylaminoethyl Acrylate | — | — | A |
| | Epoxy | | | | | |
| | Compound I | | | | | |
| Example 5 | Alicyclic | — | 3-Aminopropyltrimethoxysilane | — | — | A |
| | Epoxy | | | | | |
| | Compound I | | | | | |
| Example 6 | Alicyclic | GMA | — | Trimethoxysilylpropyl | GMA | A |
| | Epoxy | | | Methacrylate | | |
| | Compound I | | | | | |
| Example 7 | Alicyclic | — | — | Trimethoxysilylpropyl | GMA | B |
| | Epoxy | | | Methacrylate | | |
| | Compound II | | | | | |
| Comparative | Alicyclic | — | — | — | — | C |
| Example 1 | Epoxy | | | | | |
| | Compound | | | | | |
| Comparative | Alicyclic | — | — | Trimethoxysilylpropyl | GMA | C |
| Example 2 | Epoxy | | | Methacrylate | | |
| | Compound | | | | | |
| Comparative | Alicyclic | — | — | — | — | B |
| Example 3 | Epoxy | | | | | |
| | Compound I | | | | | |
| Comparative | Alicyclic | — | — | — | — | B |
| Example 4 | Epoxy | | | | | |
| | Compound I | | | | | |
| Comparative | Alicyclic | — | — | — | GMA | B |
| Example 5 | Epoxy | | | | | |
| | Compound I | | | | | |
| Comparative | Alicyclic | — | — | Trimethoxysilylpropyl | — | B |
| Example 6 | Epoxy | | | Methacrylate | | |
| | Compound I | | | | | |
| Comparative | Alicyclic | — | — | Trimethoxysilylpropyl | GMA | A |
| Example 7 | Epoxy | | | Methacrylate | | |
| | Compound I | | | | | |

| | Barrier Film | | | | |
|---|---|---|---|---|---|
| | | Thickness of | Evaluation Result | | |
| | Barrier | Intermediate | Light | Brightness | |
| | Layer | Layer | Fastness | Durability | Adhesiveness |
| Example 1 | SiN | 1 μm | A | A | A |
| Example 2 | SiN | 1 μm | A | A | A |
| Example 3 | SiN | 1 μm | A | A | A |
| Example 4 | SiN | 1 μm | A | A | A |
| Example 5 | SiN | 30 nm | A | A | A |
| Example 6 | SiN | 1 μm | A | A | A |
| Example 7 | SiN | 1 μm | B | B | A |
| Comparative | SiN | None | C | C | B |
| Example 1 | | | | | |
| Comparative | SiN | 1 μm | C | C | B |
| Example 2 | | | | | |
| Comparative | SiN | None | A | A | C |
| Example 3 | | | | | |
| Comparative | SiN | 1 μm | A | A | C |
| Example 4 | | | | | |
| Comparative | SiN | 1 μm | A | A | C |
| Example 5 | | | | | |
| Comparative | SiN | 1 μm | A | A | C |
| Example 6 | | | | | |
| Comparative | None | 1 μm | C | C | A |
| Example 7 | | | | | |

### EXPLANATION OF REFERENCES

1C: surface light source
1D: wavelength conversion member
2: backlight unit
2A: reflection plate
2B: retroreflecting member
3: liquid crystal cell unit
4: liquid crystal display device
10, 20: barrier film
11, 21: substrate
12a, 22a: barrier layer
12b. 22b: barrier coating layer (intermediate layer)
13: unevenness imparting layer (mat layer, light diffusion layer)
30: wavelength conversion layer
30A. 30B: quantum dots
30P: organic matrix
40A: adherence agent having chemical structure A
40B: adherence agent having chemical structure B
40AB: adherence agent having chemical structures A and B
L_{B}: excitation light (primary light, blue light)
L_{R}: red light (secondary light, fluorescence)
L_{G}: green light (secondary light, fluorescence)

What is claimed is:

1. A wavelength conversion member comprising:
a wavelength conversion layer including at least one kind of quantum dots that are excited by excitation light to emit fluorescence and are dispersed in an organic matrix;
an intermediate layer that is provided adjacent to at least one main surface of the wavelength conversion layer; and
a barrier layer that is provided adjacent to a main surface of the intermediate layer opposite to the wavelength conversion layer and includes silicon nitride and/or silicon oxynitride as a major component,
wherein the organic matrix is obtained by curing a curable composition including at least an alicyclic epoxy compound, and
the intermediate layer includes a chemical structure A which is bonded to silicon nitride and/or silicon oxynitride as a major component of the barrier layer and a chemical structure B which is bonded to the organic matrix.

2. The wavelength conversion member according to claim 1,
wherein the intermediate layer includes the chemical structure A and the chemical structure B in an organic layer.

3. The wavelength conversion member according to claim 1,
wherein the chemical structure A is bonded to the intermediate layer through a chemical structure C.

4. The wavelength conversion member according to claim 1,
wherein the chemical structure B is bonded to the intermediate layer through a chemical structure D.

5. The wavelength conversion member according to claim 1,
wherein the intermediate layer includes an adherence agent having the chemical structure A and an adherence agent having the chemical structure B.

6. The wavelength conversion member according to claim 1,
wherein the chemical structure A forms a covalent bond with silicon nitride and/or silicon oxynitride as a major component of the barrier layer.

7. The wavelength conversion member according to claim 1,
wherein the chemical structure A forms a hydrogen bond with silicon nitride and/or silicon oxynitride as a major component of the barrier layer.

8. The wavelength conversion member according to claim 6,
wherein the chemical structure A forms a siloxane bond with silicon nitride and/or silicon oxynitride as a major component of the barrier layer.

9. The wavelength conversion member according to claim 7,
wherein the chemical structure A has a hydrogen bond based on at least one of an amino group, a mercapto group, or a urethane structure.

10. The wavelength conversion member according to claim 1,
wherein the chemical structure B forms a covalent bond with the organic matrix.

11. The wavelength conversion member according to claim 1,
wherein the chemical structure B forms a hydrogen bond with the organic matrix.

12. The wavelength conversion member according to claim 10,
wherein the chemical structure B has a covalent bond based on at least one of an amino group, a mercapto group, or an epoxy group.

13. The wavelength conversion member according to claim 11,
wherein the chemical structure B has a hydrogen bond based on at least one of an amino group, a carboxyl group, or a hydroxy group.

14. The wavelength conversion member according to claim 1,
wherein the barrier layer includes silicon nitride as a major component.

15. The wavelength conversion member according to claim 1,
wherein the alicyclic epoxy compound is represented by the following formula.

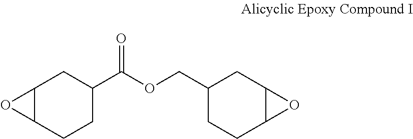 [SMILES: O=C(OCC1CCC2OC2C1)C1CCC2OC2C1]

16. A backlight unit comprising:
a surface light source that emits primary light;
the wavelength conversion member according to claim 1 that is provided on the surface light source;
a retroreflecting member that is disposed to face the surface light source with the wavelength conversion member interposed therebetween; and
a reflection plate that is disposed to face the wavelength conversion member with the surface light source interposed therebetween,
wherein the wavelength conversion member is excited by excitation light, which is at least a portion of the primary light emitted from the surface light source, to emit the fluorescence and emits at least light which includes secondary light including the fluorescence.

17. A liquid crystal display device comprising:
the backlight unit according to claim 16; and
a liquid crystal cell unit that is disposed to face the retroreflecting member side of the backlight unit.
